(19) United States
(12) Patent Application Publication
(10) Pub. No.: US 2025/0358674 A1
(43) Pub. Date: Nov. 20, 2025

(54) DETECTION DEVICE, DETECTION SYSTEM, AND DETECTION METHOD

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventors: Takanori MIYOSHI, Osaka-shi, Osaka (JP); Kunito FUKUDA, Osaka-shi, Osaka (JP); Hiroyuki TSUKAMOTO, Osaka-shi, Osaka (JP); Kyosuke MASUKAWA, Osaka-shi, Osaka (JP); Hiroshi UEDA, Yokkaichi-shi, Mie (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/870,607

(22) PCT Filed: Apr. 14, 2023
(86) PCT No.: PCT/JP2023/015147

§ 371 Date: Nov. 29, 2024

(30) Foreign Application Priority Data
May 31, 2022 (JP) 2022-088140

(51) Int. Cl. H04W 28/02

(52) U.S. Cl. CPC H04W 28/0289

(57) ABSTRACT

This detection device is a detection device configured to detect an abnormality in a network. In the network, transmission and reception of a plurality of messages including a response message are performed by a plurality of communication apparatuses. The detection device includes: an acquisition unit configured to acquire a plurality of pieces of load information respectively indicating communication loads at a plurality of locations in the network, the plurality of pieces of load information respectively indicating communication loads due to the messages whose transmission sources are corresponding ones of the communication apparatuses; and a detection unit configured to detect an abnormality in the network, based on consistency between the plurality of pieces of load information acquired by the acquisition unit.

### TECHNICAL FIELD

The present disclosure relates to a detection device, a detection system, and a detection method.

This application claims priority on Japanese Patent Application No. 2022-88140 filed on May 31, 2022, the entire content of which is incorporated herein by reference.

### BACKGROUND ART

PATENT LITERATURE 1 (International Publication No. WO2020/234940) discloses a caution-needed IP address estimation device as below. That is, the caution-needed IP address estimation device includes: an acquisition means configured to acquire, based on the degree of exposure of a subject covered by mass media, an IP address associated with the subject as a caution-needed IP address; and a transmission means configured to transmit the caution-needed IP address to an NW monitoring information database device.

PATENT LITERATURE 2 (Japanese Laid-open Patent Publication No. 2021-507375 (translation of PCT International Application)) discloses a method for monitoring a device, as below. That is, the method includes: a step of accessing a first indicator associated with a first device and indicating a security risk level; a step of accessing communication information associated with the first device; a step of determining, by a processing device, based on the communication information, a second device in communication with the first device; a step of setting a second indicator associated with the second device, based on information associated with the first device; and a step of storing the second indicator associated with the second device.

### CITATION LIST

### Patent Literature

PATENT LITERATURE 1: International Publication No. WO2020/234940

PATENT LITERATURE 2: Japanese Laid-open Patent Publication No. 2021-507375 (translation of PCT International Application)

### SUMMARY OF THE INVENTION

A detection device of the present disclosure is configured to detect an abnormality in a network. In the network, transmission and reception of a plurality of messages including a response message are performed by a plurality of communication apparatuses. The detection device includes: an acquisition unit configured to acquire a plurality of pieces of load information respectively indicating communication loads at a plurality of locations in the network, the plurality of pieces of load information respectively indicating communication loads due to the messages whose transmission sources are different from each other; and a detection unit configured to detect an abnormality in the network, based on consistency between the plurality of pieces of load information acquired by the acquisition unit.

A detection system of the present disclosure is configured to detect an abnormality in a network. In the network, transmission and reception of a plurality of messages including a response message are performed by a plurality of communication apparatuses. The detection system includes: a plurality of extraction devices configured to respectively extract the messages whose transmission sources are different from each other, the messages respectively passing through locations different from each other in the network; a plurality of observation units configured to respectively observe the messages extracted by the plurality of extraction devices; a load calculation unit configured to generate, based on observation results by the plurality of observation units, a plurality of pieces of load information respectively indicating communication loads at a plurality of locations in the network; and a detection unit configured to detect an abnormality in the network, based on consistency between the plurality of pieces of load information generated by the load calculation unit.

A detection method of the present disclosure is performed in a detection device configured to detect an abnormality in a network. In the network, transmission and reception of a plurality of messages including a response message are performed by a plurality of communication apparatuses. The detection method includes the steps of: acquiring a plurality of pieces of load information respectively indicating communication loads at a plurality of locations in the network, the plurality of pieces of load information respectively indicating communication loads due to the messages whose transmission sources are different from each other; and detecting an abnormality in the network, based on consistency between the plurality of pieces of load information having been acquired.

An aspect of the present disclosure can be realized not only as a detection device including such a characteristic processing unit, but also as a program for causing a computer to execute steps of such characteristic processing, or as a semiconductor integrated circuit that realizes a part or the entirety of the detection device.

### BRIEF DESCRIPTION OF DRAWINGS

FIG. 1 shows an example of a configuration of a detection system and a detection target network according to a first embodiment of the present disclosure.

FIG. 2 shows a state where an unauthorized apparatus is added to the detection target network of the detection system according to the first embodiment of the present disclosure.

FIG. 3 shows an example of a detection process performed by a detection device according to the first embodiment of the present disclosure.

FIG. 4 is a flowchart of an example of an operation procedure when the detection device according to the first embodiment of the present disclosure performs the detection process.

FIG. 5 shows an example of a configuration of a detection system and a detection target network according to a second embodiment of the present disclosure.

FIG. 6 shows a state where an unauthorized apparatus is added to the detection target network of the detection system according to the second embodiment of the present disclosure.

FIG. 7 shows an example of a detection process performed by a detection device according to the second embodiment of the present disclosure.

FIG. 8 shows an example of a sequence of the detection process performed in the detection system according to the second embodiment of the present disclosure.

FIG. 9 shows an example of a configuration of a detection system and a detection target network according to a third embodiment of the present disclosure.

FIG. 10 shows an example of a detection process performed by a detection device according to the third embodiment of the present disclosure.

FIG. 11 shows an example of a configuration of a detection system and a detection target network according to a fourth embodiment of the present disclosure.

FIG. 12 shows a state where an unauthorized apparatus is added to the detection target network of the detection system according to the fourth embodiment of the present disclosure.

FIG. 13 shows an example of a configuration of a detection system and a detection target network according to a fifth embodiment of the present disclosure.

FIG. 14 shows an example of a detection process performed by a detection device according to the fifth embodiment of the present disclosure.

FIG. 15 shows an example of a response information table stored in a storage unit in the detection device according to the fifth embodiment of the present disclosure.

### DETAILED DESCRIPTION

To date, technologies for detecting an abnormality such as an unauthorized access in a network have been proposed.

### Problems to be Solved by the Present Disclosure

The technology described in PATENT LITERATURE 1 is a technology that quickly detects increase in communication load by monitoring a caution-needed IP address on a network, but it is necessary to acquire information of the communication load during normal time in advance. In addition, in the technology described in PATENT LITERATURE 1, every time the network configuration is changed, it is necessary to reacquire information of the communication load during normal time in the network after the change. In the technology described in PATENT LITERATURE 2 as well, it is necessary to acquire information of traffic during normal time in advance, and every time the network configuration is changed, it is necessary to reacquire information of traffic during normal time in the network after the change.

Beyond the technologies described in PATENT LITERATURES 1 and 2, a technology that can stably detect an abnormality in a network by using less information is desired.

The present disclosure has been made in order to solve the above-described problem. An object of the present disclosure is to provide a detection device, a detection system, and a detection method that can stably detect an abnormality in a network by using less information.

### Effects of the Present Disclosure

According to the present disclosure, an abnormality in a network can be stably detected by using less information.

### Description of Embodiment of the Present Disclosure

First, contents of embodiments of the present disclosure are listed and described.

(1) A detection device according to an embodiment of the present disclosure is configured to detect an abnormality in a network. In the network, transmission and reception of a plurality of messages including a response message are performed by a plurality of communication apparatuses. The detection device includes: an acquisition unit configured to acquire a plurality of pieces of load information respectively indicating communication loads at a plurality of locations in the network, the plurality of pieces of load information respectively indicating communication loads due to the messages whose transmission sources are different from each other; and a detection unit configured to detect an abnormality in the network, based on consistency between the plurality of pieces of load information acquired by the acquisition unit.

Thus, due to the configuration in which an abnormality in the network is detected based on the consistency between a plurality of pieces of load information respectively indicating communication loads at a plurality of locations in the network, an abnormality can be detected without using the load information during normal time in the network. Therefore, an abnormality can be detected without acquiring the load information during normal time in advance or acquiring, every time the network configuration is changed, the load information during normal time in the network after the change. Therefore, an abnormality in the network can be stably detected by using less information.

(2) In (1) above, the acquisition unit may acquire three or more pieces of the load information respectively indicating communication loads at three or more locations in the network, and the detection unit may identify an abnormality location in the network, based on the consistency for each combination of two pieces of the load information included in the three or more pieces of load information.

Accordingly, the abnormality location in the network can be more specifically identified.

(3) In (1) or (2) above, in the network, transmission and reception of the messages may be performed between a first of the communication apparatuses and a plurality of the communication apparatuses different from the first communication apparatus, the acquisition unit may acquire a first of the load information indicating a communication volume of the message whose transmission source is the first communication apparatus, and a second of the load information indicating a communication volume of the message whose transmission source is the communication apparatus different from the first communication apparatus, and the detection unit may detect an abnormality in the network, based on the consistency between the communication volume of the message indicated by the first load information and the communication volume of the message indicated by the second load information.

With this configuration, an abnormality in the network in which one-to-many communication is performed can be detected.

(4) In any of (1) to (3) above, the detection device may further include an observation unit configured to observe an output, of the message having been extracted, performed by an extraction device, the extraction device being configured to extract the message transmitted from the communication apparatus, the extraction device being configured to output the message having been extracted, to another of the communication apparatuses and the detection device, and the acquisition unit may generate the load information, based on an observation result from the observation unit.

With this configuration, the degree of freedom of the measurement position of the communication load in the network can be enhanced.

(5) In (3) above, the acquisition unit may acquire the load information indicating a communication load calculated based on a number of the response messages predicted based on a type of the message transmitted by the first communication apparatus and the communication volume of the message transmitted by the first communication apparatus.

With this configuration, an abnormality in the network can be detected by using the load information based on the number of response messages to the first communication apparatus predicted based on the type of the message. Therefore, an abnormality in the network in which various types of messages such as a multicast message and a broadcast message are transmitted and received can be detected.

(6) In (5) above, the acquisition unit may acquire the load information indicating a communication load calculated based on a number of the response messages predicted further based on header information of the message transmitted by the first communication apparatus.

With this configuration, the number of response messages can be predicted based on the type and contents of the message. Therefore, an abnormality in the network in which various types of messages are transmitted and received can be more accurately detected.

(7) A detection system according to an embodiment of the present disclosure is configured to detect an abnormality in a network. In the network, transmission and reception of a plurality of messages including a response message are performed by a plurality of communication apparatuses. The detection system includes: a plurality of extraction devices configured to respectively extract the messages whose transmission sources are different from each other, the messages respectively passing through locations different from each other in the network; a plurality of observation units configured to respectively observe the messages extracted by the plurality of extraction devices; a load calculation unit configured to generate, based on observation results by the plurality of observation units, a plurality of pieces of load information respectively indicating communication loads at a plurality of locations in the network; and a detection unit configured to detect an abnormality in the network, based on consistency between the plurality of pieces of load information generated by the load calculation unit.

Thus, due to the configuration in which an abnormality in the network is detected based on the consistency between a plurality of pieces of load information respectively indicating communication loads at a plurality of locations in the network, an abnormality can be detected without using the load information during normal time in the network. Therefore, an abnormality can be detected without acquiring the load information during normal time in advance or acquiring, every time the network configuration is changed, the load information during normal time in the network after the change. Therefore, an abnormality in the network can be stably detected by using less information.

(8) A detection method according to an embodiment of the present disclosure is performed in a detection device configured to detect an abnormality in a network. In the network, transmission and reception of a plurality of messages including a response message are performed by a plurality of communication apparatuses. The detection method includes the steps of: acquiring a plurality of pieces of load information respectively indicating communication loads at a plurality of locations in the network, the plurality of pieces of load information respectively indicating communication loads due to the messages whose transmission sources are different from each other; and detecting an abnormality in the network, based on consistency between the plurality of pieces of load information having been acquired.

Thus, due to the method in which an abnormality in the network is detected based on the consistency between a plurality of pieces of load information respectively indicating communication loads at a plurality of locations in the network, an abnormality can be detected without using the load information during normal time in the network. Therefore, an abnormality can be detected without acquiring the load information during normal time in advance or acquiring, every time the network configuration is changed, the load information during normal time in the network after the change. Therefore, an abnormality in the network can be stably detected by using less information.

Hereinafter, embodiments of the present disclosure will be described with reference to the drawings. In the drawings, the same or corresponding parts are denoted by the same reference signs, and descriptions thereof are not repeated. At least some parts of the embodiments described below can be combined together as desired.

### First Embodiment

### Configuration and Basic Operation

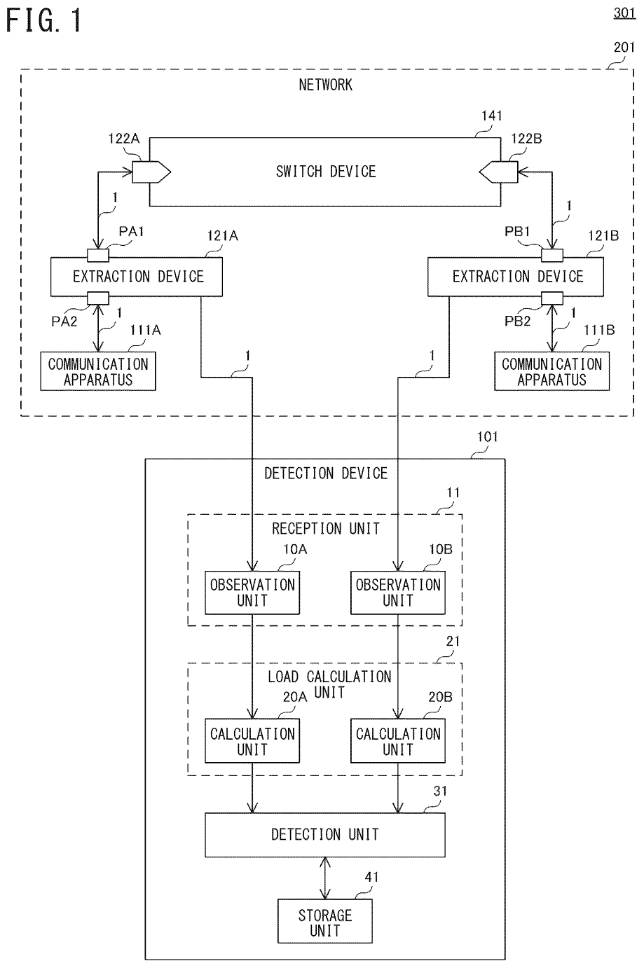

FIG. 1 shows an example of a configuration of a detection system and a detection target network according to a first embodiment of the present disclosure. With reference to FIG. 1, a detection system 301 includes a detection device 101 and extraction devices 121A, 121B. The extraction devices 121A, 121B are an example of an extraction device. The extraction device 121A includes communication ports PA1, PA2. The extraction device 121B includes communication ports PB1, PB2. The extraction device 121A transmits a message received via one of the communication ports PA1, PA2, via the other of the communication ports PA1, PA2. The extraction device 121B transmits a message received via one of the communication ports PB1, PB2, via the other of the communication ports PB1, PB2. The detection system 301 detects an abnormality in a network 201.

The network 201 includes communication apparatuses 111A, 111B, which are each a communication apparatus 111, and a switch device 141. The switch device 141 relays information exchanged between the communication apparatuses 111A, 111B. The switch device 141 includes communication ports 122A, 122B. The communication ports 122A, 122B are each a connector or a terminal, for example. The network 201 may be an in-vehicle network, a home network, or a factory automation network.

The communication apparatus 111A is connected to the communication port PA2 in the extraction device 121A via a transmission line 1. The communication apparatus 111B is connected to the communication port PB2 in the extraction device 121B via the transmission line 1. The communication port PA1 in the extraction device 121A is connected to the communication port 122A in the switch device 141 via the transmission line 1. The communication port PB1 in the extraction device 121B is connected to the communication port 122B in the switch device 141 via the transmission line 1. The transmission line 1 is an Ethernet (registered trademark) cable, for example.

In the network 201, transmission and reception of a plurality of messages including a response message are performed by a plurality of communication apparatuses 111.

More specifically, the plurality of communication apparatuses 111 each perform, as a response to a reception message received from another communication apparatus 111, transmission and reception of a message in accordance with a predetermined communication protocol Prtl, such as an ARP (Address Resolution Protocol) and SOME/IP (Scalable service-Oriented MiddlewarE over IP), for transmitting a response message to the other communication apparatus 111.

For example, the communication apparatus 111A operating as a client periodically or non-periodically generates a message addressed to the communication apparatus 111B according to the communication protocol Prtl, and transmits the generated message to the switch device 141 via the transmission line 1 and the extraction device 121A. The switch device 141 transmits the message received from the communication apparatus 111A, to the communication apparatus 111B via the transmission line 1 and the extraction device 121B.

When having received a message from the communication apparatus 111A via the switch device 141, the communication apparatus 111B operating as a server generates a response message according to the communication protocol Prtl, and transmits the generated response message to the switch device 141 via the transmission line 1 and the extraction device 121B. The switch device 141 transmits the response message received from the communication apparatus 111B, to the communication apparatus 111A via the transmission line 1 and the extraction device 121A.

The extraction devices 121A, 121B extract messages whose transmission sources are different from each other, the messages respectively passing through locations different from each other in the network 201. More specifically, the extraction device 121A includes a filter fa (not shown) that extracts a message, among received messages, that includes the address of the communication apparatus 111A as the transmission source address. The extraction device 121B includes a filter fb (not shown) that extracts a message, among received messages, that includes the address of the communication apparatus 111B as the transmission source address. The extraction devices 121A, 121B have a function of a repeater hub.

The extraction device 121A duplicates the message extracted through the filter fa among the messages received via the communication port PA2. The extraction device 121A transmits the extracted message via the communication port PA1. The extraction device 121A further transmits the duplicate of the extracted message to the detection device 101 via the transmission line 1. The extraction device 121A may transmit the extracted message to the detection device 101 via the transmission line 1 and transmit the duplicate of the extracted message via the communication port PA1.

The extraction device 121B duplicates the message extracted through the filter fb among messages received via the communication port PB2. The extraction device 121B transmits the extracted message via the communication port PB1. The extraction device 121B further transmits the duplicate of the extracted message to the detection device 101 via the transmission line 1. The extraction device 121B may transmit the extracted message to the detection device 101 via the transmission line 1 and transmit the duplicate of the extracted message via the communication port PB1.

The extraction device 121A need not necessarily be configured to be connected to the communication apparatus 111A via the transmission line 1. The extraction device 121A may be an adaptor mounted to the communication apparatus 111A. In this case, the extraction device 121A extracts a message outputted from the communication apparatus 111A, outputs the extracted message to the switch device 141 via the transmission line 1, and outputs a duplicate of the extracted message to the detection device 101 via the transmission line 1.

The extraction device 121B need not necessarily be configured to be connected to the communication apparatus 111B via the transmission line 1. The extraction device 121B may be an adaptor mounted to the communication apparatus 111B. In this case, the extraction device 121B extracts a message outputted from the communication apparatus 111B, outputs the extracted message to the switch device 141 via the transmission line 1, and outputs a duplicate of the extracted message to the detection device 101 via the transmission line 1.

### Detection Device

The detection device 101 includes a reception unit 11, a load calculation unit 21, a detection unit 31, and a storage unit 41. The reception unit 11 includes observation units 10A, 10B, which are each an observation unit 10. The load calculation unit 21 includes calculation units 20A, 20B, which are each a calculation unit 20. The load calculation unit 21 is an example of an acquisition unit. Some or all of the reception unit 11, the load calculation unit 21, and the detection unit 31 are realized by processing circuitry including one or a plurality of processors, for example. The storage unit 41 is a nonvolatile memory included in the above processing circuitry, for example. The detection device 101 performs a detection process of detecting an abnormality in the network 201.

The storage unit 41 has stored therein network information indicating the topology of the network 201 and the communication protocol Prtl in the network 201. For example, the network information is stored in the storage unit 41 by a manager of the network 201.

The plurality of observation units 10 observe messages respectively passing through locations different from each other in the network 201. That is, the observation units 10A, 10B respectively observe messages extracted by the extraction devices 121A, 121B.

For example, the observation unit 10A observes an output of an extracted message performed by the extraction device 121A. More specifically, the observation unit 10A receives, via the transmission line 1, a message extracted by the extraction device 121A. The observation unit 10A periodically or non-periodically extracts one or a plurality of messages according to the communication protocol Prtl described above, out of one or a plurality of messages received in an observation period T1 having a predetermined length. The observation unit 10A outputs an observation result including each extracted message, to the calculation unit 20A.

For example, the observation unit 10B observes an output of an extracted message performed by the extraction device 121B. More specifically, the observation unit 10B receives, via the transmission line 1, a message extracted by the extraction device 121B. The observation unit 10B periodically or non-periodically extracts one or a plurality of messages according to the communication protocol Prtl described above, out of one or a plurality of messages received in the observation period T1. The observation unit 10B outputs an observation result including each extracted message, to the calculation unit 20B.

The load calculation unit 21 acquires a plurality of pieces of load information respectively indicating communication loads at a plurality of locations in the network 201, the plurality of pieces of load information respectively indicating communication loads due to messages whose transmission sources are different from each other. For example, the load calculation unit 21 generates respective pieces of load information, based on observation results from the respective observation units 10A, 10B.

More specifically, upon reception of an observation result from the observation unit 10A, the calculation unit 20A calculates a communication volume VA per unit time due to the message included in the received observation result. The communication volume VA indicates the communication volume per unit time due to the message that includes the address of the communication apparatus 111A as the transmission source address and that passes through the extraction device 121A. The calculation unit 20A outputs load information indicating the calculated communication volume VA, to the detection unit 31. The load information is an example of first load information.

Upon reception of an observation result from the observation unit 10B, the calculation unit 20B calculates a communication volume VB per unit time due to the message included in the received observation result. The communication volume VB indicates the communication volume per unit time due to the message that includes the address of the communication apparatus 111B as the transmission source address and that passes through the extraction device 121B. The calculation unit 20B outputs load information indicating the calculated communication volume VB, to the detection unit 31. The load information is an example of second load information.

The detection unit 31 performs a detection process, based on consistency among a plurality of pieces of load information generated by the load calculation unit 21.

For example, upon reception of the load information from the calculation units 20A, 20B, the detection unit 31 determines whether or not an abnormality has occurred in the network 202, based on a comparison result between the communication volume VA indicated by the load information received from the calculation unit 20A and the communication volume VB indicated by the load information received from the calculation unit 20B.

More specifically, when the absolute value of the difference between the communication volume VA and the communication volume VB is less than a predetermined value, the detection unit 31 determines that no abnormality in the network 201 has occurred, and stores the determination result into the storage unit 41. On the other hand, when the absolute value of the difference between the communication volume VA and the communication volume VB is equal to or larger than the predetermined value, the detection unit 31 determines that an abnormality in the network 201 has occurred, and stores the determination result into the storage unit 41. For example, when having determined that an abnormality in the network 201 has occurred, the detection unit 31 notifies the manager of the network 201 of the determination result by means of a sound or a display. The detection unit 31 may be configured to notify a management device (not shown) of the determination result via the network 201 or another network (not shown).

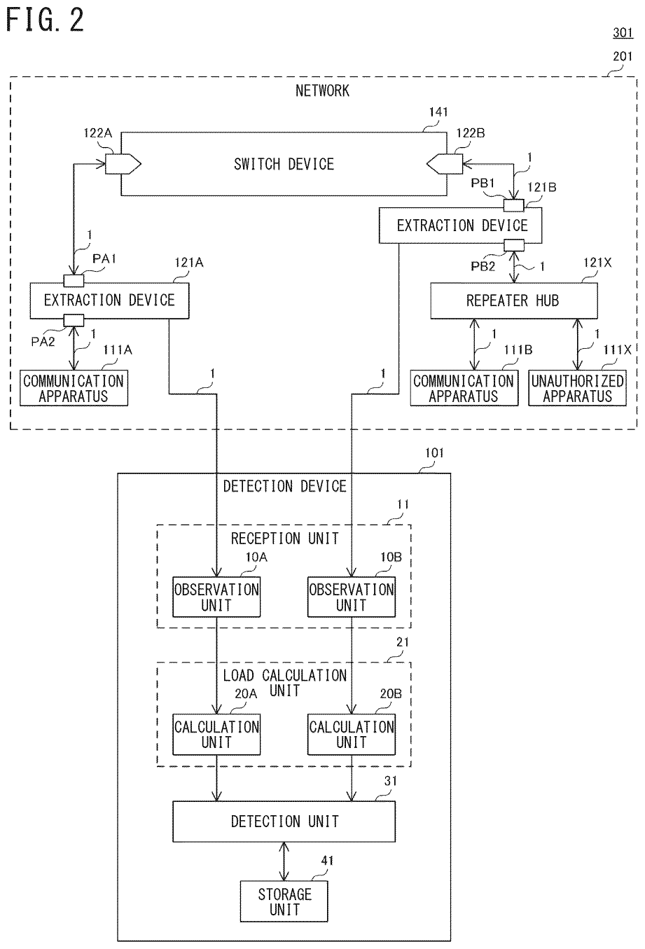

FIG. 2 shows a state where an unauthorized apparatus is added to the detection target network of the detection system according to the first embodiment of the present disclosure. FIG. 2 shows a state where an unauthorized apparatus 111X and a repeater hub 121X are added to the network 201. The repeater hub 121X is provided between the extraction device 121B and the communication apparatus 111B, and is connected to the communication port PB2 in the extraction device 121B via the transmission line 1. The unauthorized apparatus 111X is connected to the repeater hub 121X via the transmission line 1.

The unauthorized apparatus 111X generates an unauthorized message addressed to the communication apparatus 111A according to the communication protocol Prtl and pretending as if the transmission source thereof were the communication apparatus 111B, and transmits the generated unauthorized message to the repeater hub 121X.

The repeater hub 121X outputs a message received from the communication apparatus 111B, to the extraction device 121B and the unauthorized apparatus 111X, outputs a message received from the extraction device 121B, to the communication apparatus 111B and the unauthorized apparatus 111X, and outputs the unauthorized message received from the unauthorized apparatus 111X, to the communication apparatus 111B and the extraction device 121B.

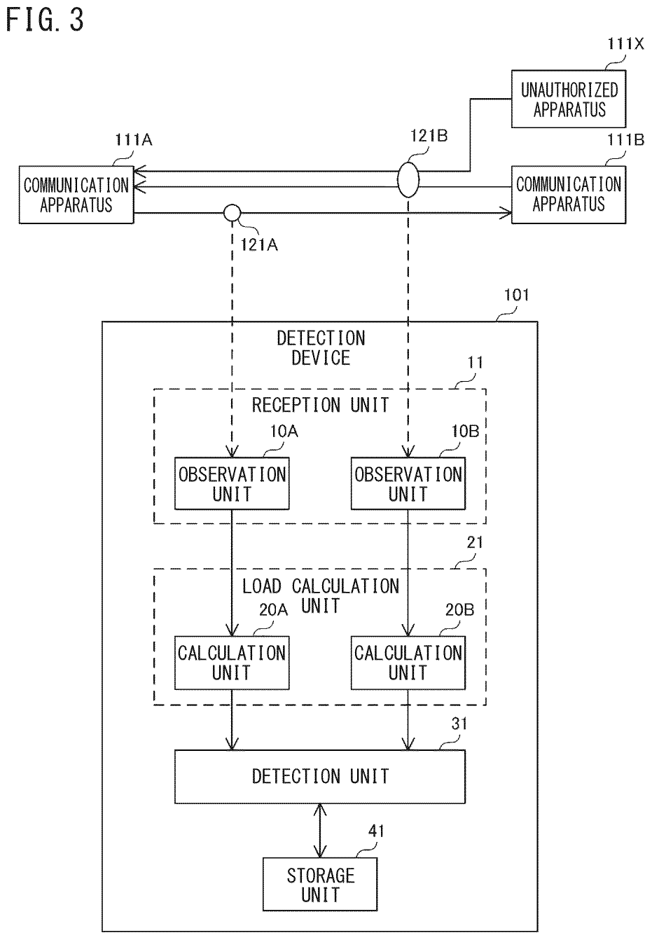

FIG. 3 shows an example of the detection process performed by the detection device according to the first embodiment of the present disclosure.

With reference to FIG. 3, for example, the communication apparatus 111A transmits a message to the communication apparatus 111B via the switch device 141. The observation unit 10A in the reception unit 11 of the detection device 101 receives, via the transmission line 1, the message transmitted by the communication apparatus 111A and extracted by the extraction device 121A.

The communication apparatus 111B receives the message from the communication apparatus 111A via the switch device 141, and transmits a response message to the communication apparatus 111A via the switch device 141. The unauthorized apparatus 111X transmits an unauthorized message to the communication apparatus 111A via the switch device 141. The unauthorized message transmitted by the unauthorized apparatus 111X is outputted to the communication apparatus 111B by the repeater hub 121X. The observation unit 10B in the reception unit 11 of the detection device 101 receives, via the transmission line 1, the response message transmitted by the communication apparatus 111B and extracted by the extraction device 121B, and in addition, the unauthorized message transmitted by the unauthorized apparatus 111X and extracted by the extraction device 121B.

Accordingly, the communication volume VB calculated by the calculation unit 20B has a value larger than that of the communication volume VA calculated by the calculation unit 20A.

In this case, the detection unit 31 determines that an abnormality in the network 201 has occurred since the absolute value of the difference between the communication volume VA and the communication volume VB is equal to or larger than the predetermined value.

### Operation Flow

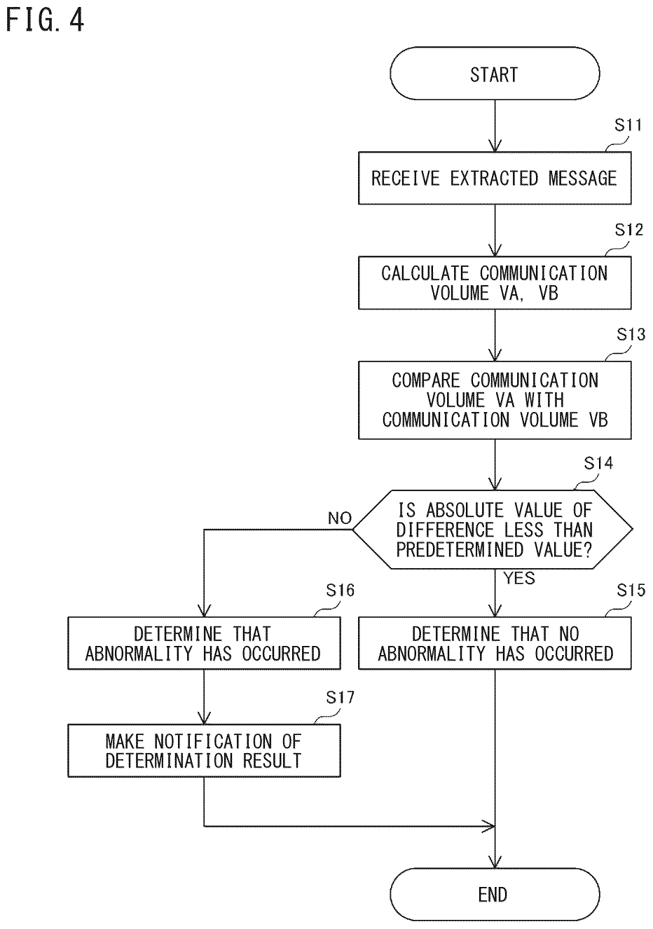

FIG. 4 is a flowchart of an example of an operation procedure when the detection device according to the first embodiment of the present disclosure performs the detection process.

With reference to FIG. 4, first, the detection device 101 observes respective messages passing through locations different from each other in the network 201. More specifically, the detection device 101 receives, via the transmission line 1, a message extracted by the extraction device 121A, and receives, via the transmission line 1, a message extracted by the extraction device 121B (step S11).

Next, based on the observation result of the messages, the detection device 101 generates a plurality of pieces of load information respectively indicating communication loads at a plurality of locations in the network 201. More specifically, the detection device 101 calculates the communication volume VA per unit time due to the message received from the extraction device 121A and the communication volume VB per unit time due to the message received from the extraction device 121B (step S12).

Next, the detection device 101 compares the communication volume VA and the communication volume VB with each other (step S13).

Next, when the absolute value of the difference between the communication volume VA and the communication volume VB is less than a predetermined value (YES in step S14), the detection device 101 determines that no abnormality in the network 201 has occurred (step S15).

On the other hand, when the absolute value of the difference between the communication volume VA and the communication volume VB is equal to or larger than the predetermined value (NO in step S14), the detection device 101 determines that an abnormality in the network 201 has occurred (step S16).

Next, the detection device 101 notifies the manager of the network 201 of the determination result by means of a sound or a display (step S17).

In the detection device 101 according to the embodiment of the present disclosure, the calculation unit 20 in the load calculation unit 21 is configured to calculate the communication volume per unit time due to the message included in the observation result received from the observation unit 10, but the present disclosure is not limited thereto. The calculation unit 20 may be configured to acquire the communication volume from outside the detection device 101, instead of calculating the communication volume. That is, the load calculation unit 21 may acquire load information generated outside the detection device 101, instead of generating the load information.

In the detection system 301 according to the embodiment of the present disclosure, the extraction device 121A is configured to duplicate a message extracted through the filter fa among messages received via the communication port PA2, transmit the extracted message via the communication port PA1, and transmit a duplicate of the extracted message to the detection device 101 via the transmission line 1. However, the present disclosure is not limited thereto. The extraction device 121A may be configured to duplicate all the messages received via the communication port PA2, transmit, via the communication port PA1, all the messages received via the communication port PA2, and transmit a message extracted through the filter fa among duplicates of messages having been extracted, to the detection device 101 via the transmission line 1.

A configuration in which, instead of the extraction device 121A, the observation unit 10A includes the filter fa may be adopted. In this case, the extraction device 121A duplicates all the messages received via the communication port PA2, transmits, via the communication port PA1, all the messages received via the communication port PA2, and transmits duplicates of messages having been extracted, to the detection device 101 via the transmission line 1. The observation unit 10A extracts a message according to the communication protocol Prtl described above out of messages extracted through the filter fa among the messages received from the extraction device 121A.

Similarly, the extraction device 121B may be configured to duplicate all the messages received via the communication port PB2, transmit, via the communication port PB1, all the messages received via the communication port PB2, and transmit a message extracted through the filter fb among duplicates of messages having been extracted, to the detection device 101 via the transmission line 1. A configuration in which, instead of the extraction device 121B, the observation unit 10B includes the filter fb may be adopted. In this case, the extraction device 121B duplicates all the messages received via the communication port PB2, transmits, via the communication port PB1, all the messages received via the communication port PB2, and transmits duplicates of messages having been extracted, to the detection device 101 via the transmission line 1. The observation unit 10B extracts a message according to the communication protocol Prtl described above out of messages extracted through the filter fb among the messages received from the extraction device 121B.

Next, another embodiment of the present disclosure will be described with reference to the drawings. In the drawings, the same or corresponding parts are denoted by the same reference signs, and descriptions thereof are not repeated.

### Second Embodiment

The present embodiment relates to a detection system 302 that identifies an abnormality location, based on consistency for each combination of pieces of load information, as compared with the detection system 301 according to the first embodiment. Contents other than those described below are the same as those of the detection system 301 according to the first embodiment.

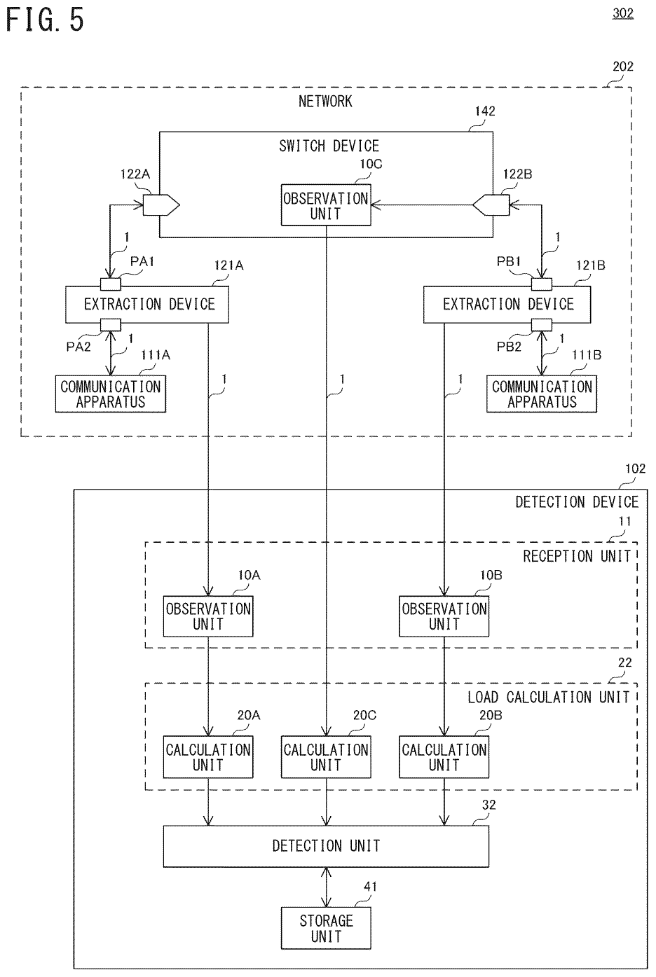

FIG. 5 shows an example of a configuration of a detection system and a detection target network according to a second embodiment of the present disclosure. With reference to FIG. 5, as compared with the detection system 301 according to the first embodiment, the detection system 302 includes a detection device 102 instead of the detection device 101, and further includes an observation unit 10C. The detection system 302 detects an abnormality in a network 202. As compared with the network 201, the network 202 includes a switch device 142 instead of the switch device 141. The observation unit 10C is provided to the switch device 142. Similar to the switch device 141, the switch device 142 includes the communication ports 122A, 122B, and relays information exchanged between the communication apparatuses 111A, 111B.

As compared with the detection device 101, the detection device 102 includes a load calculation unit 22 instead of the load calculation unit 21, and includes a detection unit 32 instead of the detection unit 31. As compared with the load calculation unit 21, the load calculation unit 22 further includes a calculation unit 20C, which is the calculation unit 20. The load calculation unit 22 generates three pieces of load information respectively indicating communication loads at three locations in the network 202. The load calculation unit 22 is an example of the acquisition unit.

The observation unit 10C observes a message that arrives at the communication port 122B in the switch device 142. More specifically, the observation unit 10C receives a message via the communication port 122B, outputs the received message to a relay processing unit (not shown), and duplicates the message. The observation unit 10C periodically or non-periodically extracts one or a plurality of messages according to the communication protocol Prtl described above, out of one or a plurality of messages duplicated in the observation period T1. The observation unit 10C transmits an observation result including each extracted message to the detection device 102 via the transmission line 1.

For example, the calculation unit 20C generates load information, based on the observation result from the observation unit 10C. More specifically, the calculation unit 20C receives the observation result from the observation unit 10C via the transmission line 1, and calculates a communication volume VC per unit time due to the message included in the received observation result. The communication volume VC indicates the communication volume per unit time due to the message received via the communication port 122B by the switch device 142. The calculation unit 20C outputs load information indicating the calculated communication volume VC, to the detection unit 32.

The detection unit 32 identifies, in a detection process, an abnormality location in the network 202, based on consistency for each combination of two pieces of load information included in the three pieces of load information received from the calculation units 20A, 20B, 20C.

For example, upon reception of the load information from the calculation units 20A, 20B, 20C, the detection unit 32 identifies an abnormality location in the network 202, based on a comparison result for each combination of two communication volumes included in the communication volumes VA, VB, VC indicated by the received three pieces of load information.

As an example, when the absolute value of the difference between the communication volume VA and the communication volume VB, the absolute value of the difference between the communication volume VB and the communication volume VC, and the absolute value of the difference between the communication volume VA and the communication volume VC are each less than a predetermined value, the detection unit 32 determines that no abnormality in the network 202 has occurred.

On the other hand, when at least one of the absolute value of the difference between the communication volume VA and the communication volume VB, the absolute value of the difference between the communication volume VB and the communication volume VC, and the absolute value of the difference between the communication volume VA and the communication volume VC is equal to or larger than the predetermined value, the detection unit 32 determines that an abnormality in the network 202 has occurred.

For example, when the value obtained by subtracting the communication volume VA from the communication volume VB is equal to or larger than a predetermined value and the value obtained by subtracting the communication volume VA from the communication volume VC is equal to or larger than a predetermined value, messages in a number larger than an assumed number have passed through the extraction device 121B toward the switch device 142, and thus, the detection unit 32 determines that an abnormality such as insertion of an unauthorized message addressed to the communication apparatus 111A has occurred between the communication apparatus 111B and the extraction device 121B.

For example, when the absolute value of the difference between the communication volume VA and the communication volume VB is less than a predetermined value and the value obtained by subtracting the communication volume VA from the communication volume VC is equal to or larger than a predetermined value, messages in a number larger than an assumed number have arrived at the communication port 122B in the switch device 142, and thus, the detection unit 32 determines that an abnormality such as insertion of an unauthorized message addressed to the communication apparatus 111A has occurred between the extraction device 121B and the switch device 142.

For example, when having determined that an abnormality in the network 202 has occurred, the detection unit 32 notifies the manager of the network 202 of the determination result including the identified abnormality location, by means of a sound or a display.

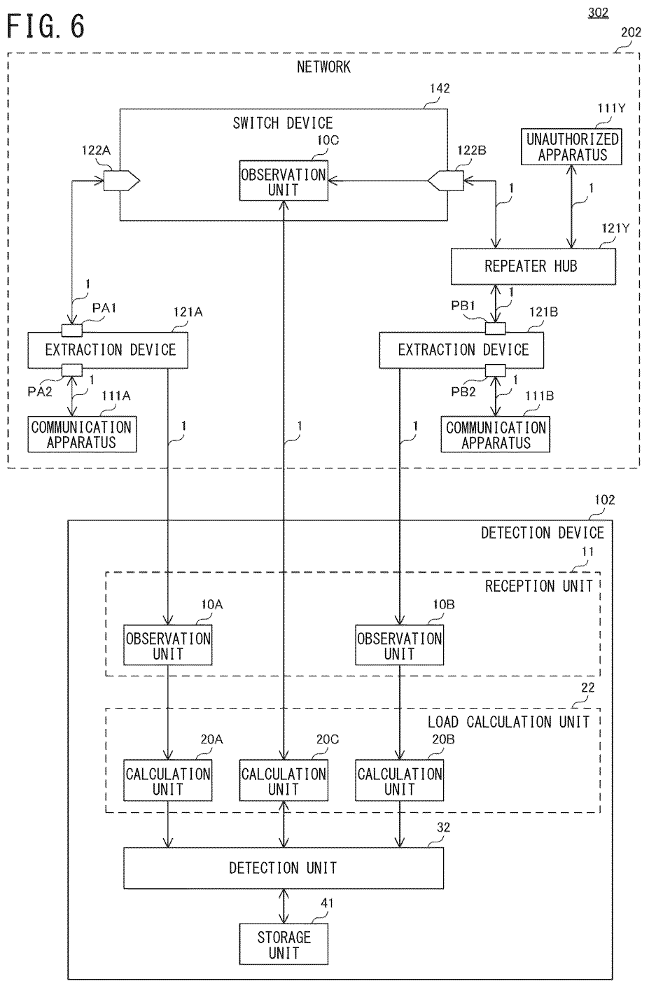

FIG. 6 shows a state where an unauthorized apparatus is added to the detection target network of the detection system according to the second embodiment of the present disclosure. FIG. 6 shows a state where an unauthorized apparatus 111Y and a repeater hub 121Y are added to the network 202. The repeater hub 121Y is provided between the communication port 122B in the switch device 142 and the extraction device 121B, and is connected to the communication port PB1 in the extraction device 121B via the transmission line 1. The unauthorized apparatus 111Y is connected to the repeater hub 121Y via the transmission line 1.

The unauthorized apparatus 111Y generates an unauthorized message addressed to the communication apparatus 111A according to the communication protocol Prtl and pretending as if the transmission source thereof were the communication apparatus 111B, and transmits the generated unauthorized message to the repeater hub 121Y.

The repeater hub 121Y outputs a message received from the extraction device 121B to the switch device 142 and the unauthorized apparatus 111Y, outputs a message received from the switch device 142 to the extraction device 121B and the unauthorized apparatus 111Y, and outputs the unauthorized message received from the unauthorized apparatus 111Y to the switch device 142 and the extraction device 121B.

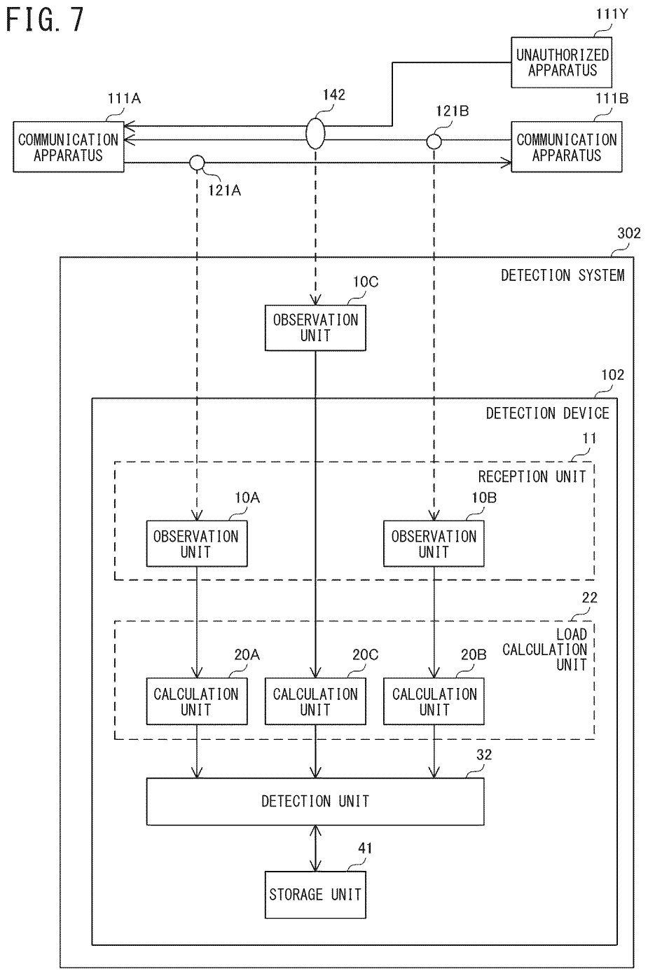

FIG. 7 shows an example of the detection process performed by the detection device according to the second embodiment of the present disclosure.

With reference to FIG. 7, for example, the communication apparatus 111A transmits a message to the communication apparatus 111B via the switch device 142. The observation unit 10A in the reception unit 11 of the detection device 102 receives, via the transmission line 1, the message transmitted by the communication apparatus 111A and extracted by the extraction device 121A.

The communication apparatus 111B receives the message from the communication apparatus 111A via the switch device 142, and transmits a response message to the communication apparatus 111A via the switch device 142. The unauthorized apparatus 111Y transmits an unauthorized message to the communication apparatus 111A via the repeater hub 121Y and the switch device 142. The unauthorized message transmitted by the unauthorized apparatus 111Y is outputted to the extraction device 121B by the repeater hub 121Y. It should be noted that, since the extraction device 121B receives the unauthorized message via the communication port PB1, the extraction device 121B transmits the unauthorized message to the communication apparatus 111B via the communication port PB2, whereas the extraction device 121B does not perform extraction of the unauthorized message through the filter fb and duplication thereof. Therefore, the unauthorized message transmitted by the unauthorized apparatus 111Y does not arrive at the observation unit 10B in the reception unit 11 of the detection device 102.

The observation unit 10B in the reception unit 11 of the detection device 102 receives, via the transmission line 1, a response message transmitted by the communication apparatus 111B and extracted by the extraction device 121B. On the other hand, the observation unit 10C receives the response message transmitted by the communication apparatus 111B, and in addition, the unauthorized message transmitted by the unauthorized apparatus 111Y.

Therefore, the communication volume VC calculated by the calculation unit 20C has a value larger than the communication volume VA calculated by the calculation unit 20A and the communication volume VB calculated by the calculation unit 20B.

In this case, since the absolute value of the difference between the communication volume VA and the communication volume VB is less than the predetermined value and the value obtained by subtracting the communication volume VA from the communication volume VC is equal to or larger than the predetermined value, the detection unit 32 determines that an abnormality has occurred between the extraction device 121B and the switch device 142.

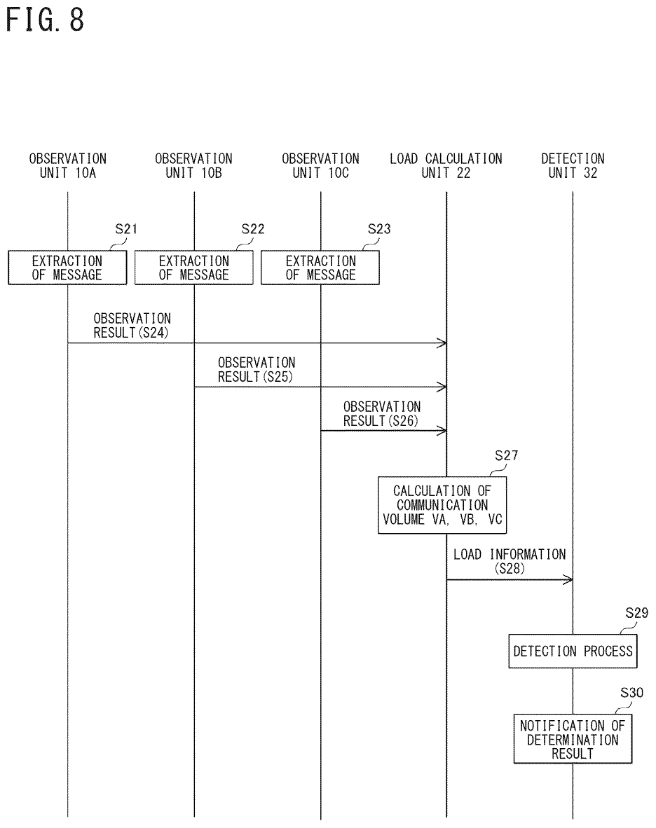

FIG. 8 shows an example of a sequence of the detection process performed in the detection system according to the second embodiment of the present disclosure.

With reference to FIG. 8, first, the observation unit 10A extracts one or a plurality of messages according to the communication protocol Prtl, out of one or a plurality of messages extracted by the extraction device 121A in the observation period T1 (step S21).

The observation unit 10B extracts one or a plurality of messages according to the communication protocol Prtl out of one or a plurality of messages extracted by the extraction device 121B in the observation period T1 (step S22).

The observation unit 10C extracts one or a plurality of messages according to the communication protocol Prtl out of one or a plurality of messages duplicated in the observation period T1 (step S23).

Next, the observation unit 10A outputs an observation result including each extracted message to the load calculation unit 22 (step S24).

The observation unit 10B outputs an observation result including each extracted message to the load calculation unit 22 (step S25).

The observation unit 10C transmits an observation result including each extracted message to the load calculation unit 22 (step S26).

Next, the load calculation unit 22 calculates the communication volume VA per unit time due to the message included in the observation result received from the observation unit 10A, the communication volume VB per unit time due to the message included in the observation result received from the observation unit 10B, and the communication volume VC per unit time due to the message included in the observation result received from the observation unit 10C (step S27).

Next, the load calculation unit 22 outputs, to the detection unit 32, load information indicating the communication volume VA, load information indicating the communication volume VB, and load information indicating the communication volume VC (step S28).

The detection unit 32 performs the detection process, based on consistency among the plurality of pieces of load information received from the load calculation unit 22. For example, when the absolute value of the difference between the communication volume VA and the communication volume VB is less than a predetermined value and the value obtained by subtracting the communication volume VA from the communication volume VC is equal to or larger than a predetermined value, the detection unit 32 determines that an abnormality has occurred between the extraction device 121B and the switch device 142 (step S29).

Next, the detection unit 32 notifies the manager of the network 202 of the determination result by means of a sound or a display (step S30).

In the detection system 302 according to the embodiment of the present disclosure, the observation unit 10C may be configured to withhold duplication and extraction of the message until receiving an observation instruction from the detection device 102 and perform, when having received the observation instruction from the detection device 102, duplication and extraction of the message.

More specifically, when having determined that an abnormality in the network 202 has occurred through comparison between the communication volume VA and the communication volume VB, the detection unit 32 in the detection device 102 outputs a calculation instruction to the calculation unit 20C.

When having received the calculation instruction from the detection unit 32, the calculation unit 20C transmits an observation instruction to the observation unit 10C via the transmission line 1.

The observation unit 10C receives the observation instruction from the calculation unit 20C, and in an observation period T2 having the same length as the observation period T1, duplicates the message received via the communication port 122B, and extracts one or a plurality of messages according to the communication protocol Prtl out of one or a plurality of messages duplicated. The observation unit 10C transmits an observation result including each extracted message to the detection device 102 via the transmission line 1.

Next, another embodiment of the present disclosure will be described with reference to the drawings. In the drawings, the same or corresponding parts are denoted by the same reference signs, and descriptions thereof are not repeated.

### Third Embodiment

The present embodiment relates to a detection system 303 that detects an abnormality in a network 203 in which one-to-many communication by communication apparatuses 111 is performed, as compared with the detection system 301 according to the first embodiment. Contents other than those described below are the same as those of the detection system 301 according to the first embodiment.

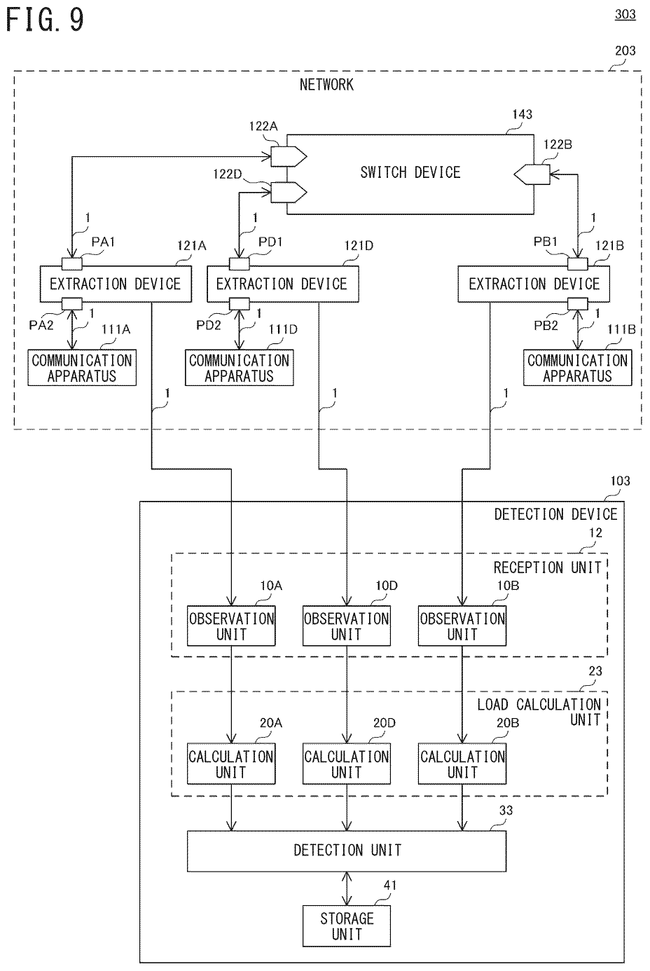

FIG. 9 shows an example of a configuration of a detection system and a detection target network according to a third embodiment of the present disclosure. With reference to FIG. 9, as compared with the detection system 301 according to the first embodiment, the detection system 303 includes a detection device 103 instead of the detection device 101, and further includes an extraction device 121D. The extraction device 121D is an example of the extraction device. The extraction device 121D includes communication ports PD1, PD2. The extraction device 121D transmits a message received via one of the communication ports PD1, PD2, via the other of the communication ports PD1, PD2. The detection system 303 detects an abnormality in the network 203.

The network 203 includes communication apparatuses 111A, 111B, 111D, which are each the communication apparatus 111, and a switch device 143. The communication apparatus 111B is an example of a first communication apparatus, the communication apparatus 111A is an example of a second communication apparatus, and the communication apparatus 111D is an example of a third communication apparatus. The switch device 143 relays information exchanged between the communication apparatuses 111A, 111D and the communication apparatus 111B. The switch device 143 includes communication ports 122A, 122B, 122D.

The communication apparatus 111D is connected to the communication port PD2 in the extraction device 121D via the transmission line 1. The communication port PD1 in the extraction device 121D is connected to the communication port 122D in the switch device 143 via the transmission line 1.

In the network 203, one-to-two communication is performed. More specifically, in the network 203, transmission and reception of messages are performed between the communication apparatus 111B and the communication apparatuses 111A, 111D different from the communication apparatus 111B. Here, in the network 203, between the communication apparatus 111A and the communication apparatus 111D, transmission and reception of messages are not performed.

For example, the communication apparatus 111A operating as a client periodically or non-periodically generates a message addressed to the communication apparatus 111B according to the communication protocol Prtl, and transmits the generated message to the switch device 143 via the transmission line 1 and the extraction device 121A. The switch device 143 transmits the message received from the communication apparatus 111A to the communication apparatus 111B via the transmission line 1 and the extraction device 121B.

When having received a message from the communication apparatus 111A via the switch device 143, the communication apparatus 111B operating as a server generates a response message according to the communication protocol Prtl, and transmits the generated response message to the switch device 143 via the transmission line 1 and the extraction device 121B. The switch device 143 transmits the response message received from the communication apparatus 111B to the communication apparatus 111A via the transmission line 1 and the extraction device 121A.

For example, the communication apparatus 111D operating as a client periodically or non-periodically generates a message addressed to the communication apparatus 111B according to the communication protocol Prtl, and transmits the generated message to the switch device 143 via the transmission line 1 and the extraction device 121D. The switch device 143 transmits the message received from the communication apparatus 111D to the communication apparatus 111B via the transmission line 1 and the extraction device 121B.

When having received a message from the communication apparatus 111D via the switch device 143, the communication apparatus 111B generates a response message according to the communication protocol Prtl, and transmits the generated response message to the switch device 143 via the transmission line 1 and the extraction device 121B. The switch device 143 transmits the response message received from the communication apparatus 111B to the communication apparatus 111D via the transmission line 1 and the extraction device 121D.

The extraction device 121D includes a filter fd (not shown) that extracts a message received via the communication port PD2 and including the address of the communication apparatus 111D as the transmission source address. The extraction device 121D has a function of a repeater hub. The extraction device 121D duplicates the message extracted through the filter fd among the messages received via the communication port PD2. The extraction device 121D transmits the extracted message via the communication port PD1. The extraction device 121D further transmits the duplicate of the extracted message to the detection device 103 via the transmission line 1.

As compared with the detection device 101 according to the first embodiment, the detection device 103 includes a reception unit 12 instead of the reception unit 11, includes a load calculation unit 23 instead of the load calculation unit 21, and includes a detection unit 33 instead of the detection unit 31. As compared with the reception unit 11, the reception unit 12 further includes an observation unit 10D, which is the observation unit 10. As compared with the load calculation unit 21, the load calculation unit 23 further includes a calculation unit 20D, which is the calculation unit 20. The load calculation unit 23 is an example of the acquisition unit. The detection device 103 performs a detection process of detecting an abnormality in the network 203 in which one-to-two communication is performed.

For example, the observation unit 10D observes an output of an extracted message performed by the extraction device 121D. More specifically, the observation unit 10D receives, via the transmission line 1, a message extracted by the extraction device 121D. The observation unit 10D periodically or non-periodically extracts one or a plurality of messages according to the communication protocol Prtl described above, out of one or a plurality of messages received in the observation period T1 having a predetermined length. The observation unit 10D outputs an observation result including each extracted message, to the calculation unit 20D.

Upon reception of the observation result from the observation unit 10D, the calculation unit 20D calculates a communication volume VD per unit time due to the message included in the received observation result. The communication volume VD indicates the communication volume per unit time due to the message that includes the address of the communication apparatus 111D as the transmission source address and that passes through the extraction device 121D. The calculation unit 20D outputs load information indicating the calculated communication volume VD, to the detection unit 33. The load information is an example of the second load information.

The detection unit 33 detects an abnormality in the network 203, based on consistency between: the communication volume VB of the message transmitted by the communication apparatus 111B; and a result obtained by integrating the communication volume VA of the message transmitted by the communication apparatus 111A and the communication volume VD of the message transmitted by the communication apparatus 111D.

For example, upon reception of the load information from the calculation units 20A, 20B, 20D, the detection unit 33 calculates a communication volume VAD, which is the sum of the communication volume VA indicated by the load information received from the calculation unit 20A and the communication volume VD indicated by the load information received from the calculation unit 20D. Then, the detection unit 33 determines whether or not an abnormality in the network 203 has occurred, based on a comparison result between the calculated communication volume VAD and the communication volume VB indicated by the load information received from the calculation unit 20B.

More specifically, when the absolute value of the difference between the communication volume VAD and the communication volume VB is less than a predetermined value, the detection unit 33 determines that no abnormality in the network 203 has occurred, and stores the determination result into the storage unit 41. On the other hand, when the absolute value of the difference between the communication volume VAD and the communication volume VB is equal to or larger than the predetermined value, the detection unit 33 determines that an abnormality in the network 203 has occurred, and stores the determination result into the storage unit 41. For example, when having determined that an abnormality in the network 203 has occurred, the detection unit 33 notifies the manager of the network 203 of the determination result by means of a sound or a display.

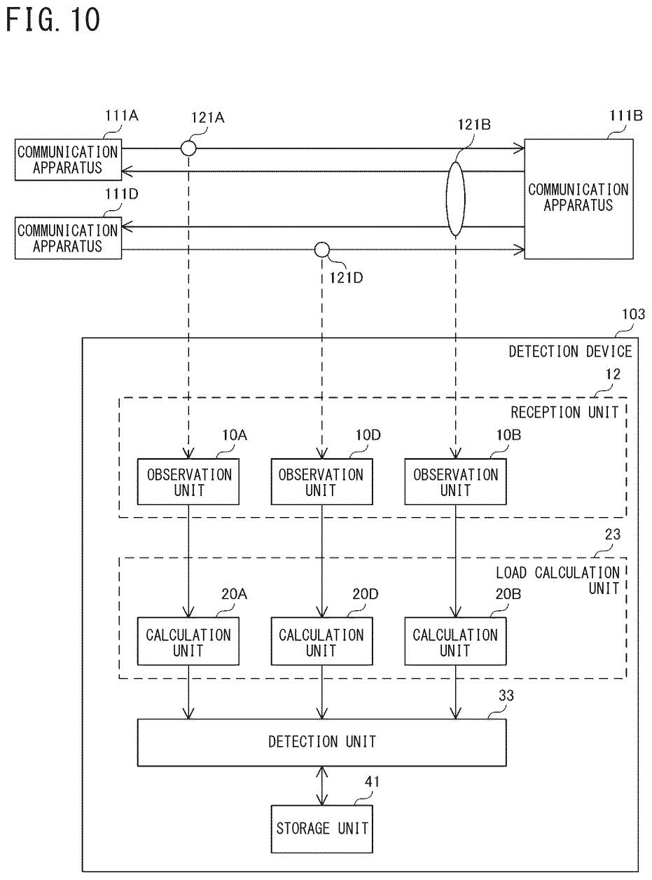

FIG. 10 shows an example of the detection process performed by the detection device according to the third embodiment of the present disclosure.

With reference to FIG. 10, for example, the communication apparatus 111A transmits a message to the communication apparatus 111B via the switch device 143. The observation unit 10A in the reception unit 12 of the detection device 103 receives, via the transmission line 1, the message transmitted by the communication apparatus 111A and extracted by the extraction device 121A.

The communication apparatus 111B receives the message from the communication apparatus 111A via the switch device 143, and transmits a response message to the communication apparatus 111A via the switch device 143. The observation unit 10B in the reception unit 12 of the detection device 103 receives, via the transmission line 1, the response message transmitted by the communication apparatus 111B and extracted by the extraction device 121B.

In addition, for example, the communication apparatus 111D transmits a message to the communication apparatus 111B via the switch device 143. The observation unit 10D in the reception unit 12 of the detection device 103 receives, via the transmission line 1, the message transmitted by the communication apparatus 111D and extracted by the extraction device 121D.

The communication apparatus 111B receives the message from the communication apparatus 111D via the switch device 143, and transmits a response message to the communication apparatus 111D via the switch device 143. The observation unit 10B in the reception unit 12 of the detection device 103 receives, via the transmission line 1, the response message transmitted by the communication apparatus 111B and extracted by the extraction device 121B.

When the network 203 is in a normal state, the difference between: the communication volume VAD, which is the sum of the communication volume VA calculated by the calculation unit 20A and the communication volume VD calculated by the calculation unit 20D; and the communication volume VB calculated by the calculation unit 20B is zero, for example. On the other hand, when an abnormality such as insertion of an unauthorized message has occurred in the network 203, the consistency between the communication volume VAD and the communication volume VB decreases and the difference between the communication volume VAD and the communication volume VB has a large value. Therefore, based on the difference between the communication volume VAD and the communication volume VB, the detection unit 33 can determine whether or not an abnormality in the network 203 has occurred.

In the detection device 103 according to the embodiment of the present disclosure, the detection unit 33 is configured to calculate the communication volume VAD and determine whether or not an abnormality in the network 203 has occurred, based on a comparison result between the calculated communication volume VAD and the communication volume VB. However, the present disclosure is not limited thereto. The detection unit 33 may be configured to calculate, as the result obtained by integrating the communication volume VA and the communication volume VD, a value, instead of the communication volume VAD, obtained by adding or subtracting a predetermined adjustment value to or from the sum of the communication volume VA and the communication volume VD, and determine whether or not an abnormality in the network 203 has occurred, based on a comparison result between the calculated value and the communication volume VB.

The detection device 103 according to the embodiment of the present disclosure is configured to detect, in the detection process, an abnormality in the network 203 in which one-to-two communication is performed. However, the present disclosure is not limited thereto. When, in the detection process, N is an integer that is 3 or larger, the detection device 103 may be configured to detect an abnormality in a network in which one-to-N or larger communication is performed. More specifically, in the network, transmission and reception of messages are performed between the communication apparatus 111B and three or more communication apparatuses 111 that are different from the communication apparatus 111B. In this case, the detection unit 33 in the detection device 103 detects an abnormality in the network, based on consistency between the communication volume VB of the message transmitted by the communication apparatus 111B and a result obtained by integrating the communication volumes of the messages respectively transmitted by the three or more communication apparatuses 111.

Next, another embodiment of the present disclosure will be described with reference to the drawings. In the drawings, the same or corresponding parts are denoted by the same reference signs, and descriptions thereof are not repeated.

### Fourth Embodiment

The present embodiment relates to a detection system 304 that identifies an abnormality location, based on consistency for each combination of pieces of load information, as compared with the detection system 303 according to the third embodiment. Contents other than those described below are the same as those of the detection system 303 according to the third embodiment.

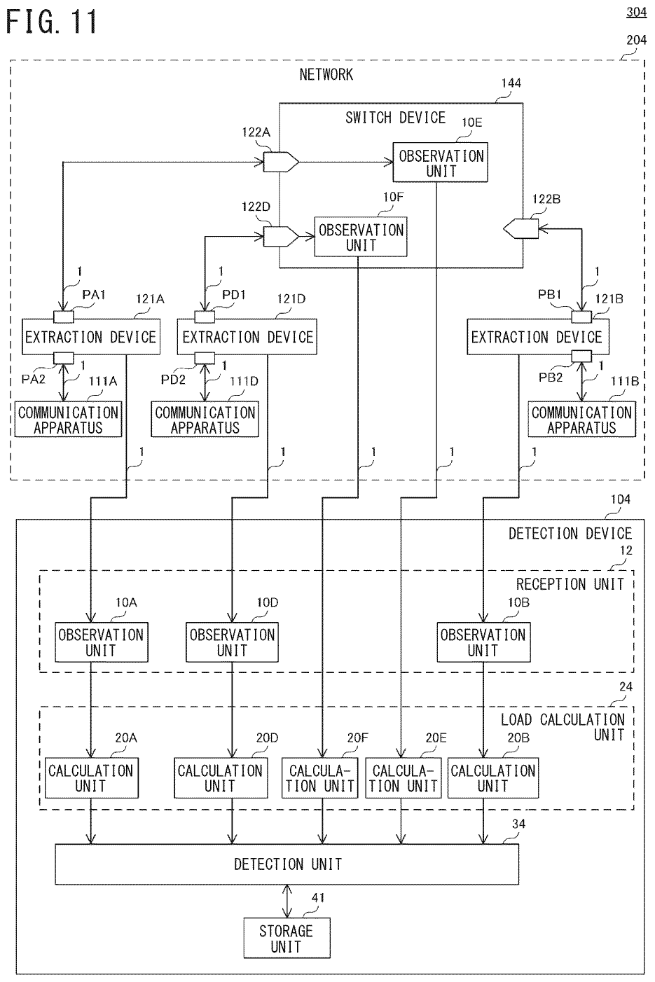

FIG. 11 shows an example of a configuration of a detection system and a detection target network according to a fourth embodiment of the present disclosure. With reference to FIG. 11, as compared with the detection system 303 according to the third embodiment, the detection system 304 includes a detection device 104 instead of the detection device 103, and further includes observation units 10E, 10F. The detection system 304 detects an abnormality in a network 204. As compared with the network 203, the network 204 includes a switch device 144 instead of the switch device 143. The observation units 10E, 10F are provided to the switch device 144. Similar to the switch device 143, the switch device 144 includes the communication ports 122A, 122B, 122D, and relays information exchanged between the communication apparatuses 111A, 111D and the communication apparatus 111B.

As compared with the detection device 103 according to the third embodiment, the detection device 104 includes a load calculation unit 24 instead of the load calculation unit 23, and includes a detection unit 34 instead of the detection unit 33. As compared with the load calculation unit 23, the load calculation unit 24 further includes calculation units 20E, 20F, which are each the calculation unit 20. The load calculation unit 24 is an example of the acquisition unit.

The observation units 10E, 10F respectively observe messages that arrive at the communication ports 122A, 122D in the switch device 144.

More specifically, the observation unit 10E receives a message via the communication port 122A, outputs the received message to a relay processing unit (not shown), and duplicates the message. The observation unit 10E periodically or non-periodically extracts one or a plurality of messages according to the communication protocol Prtl described above, out of one or a plurality of messages duplicated in the observation period T1. The observation unit 10E transmits an observation result including each extracted message to the detection device 104 via the transmission line 1.

The observation unit 10F receives a message via the communication port 122D, outputs the received message to a relay processing unit (not shown), and duplicates the message. The observation unit 10F periodically or non-periodically extracts one or a plurality of messages according to the communication protocol Prtl described above, out of one or a plurality of messages duplicated in the observation period T1. The observation unit 10F transmits an observation result including each extracted message to the detection device 104 via the transmission line 1.

For example, the calculation unit 20E generates load information, based on the observation result from the observation unit 10E. More specifically, the calculation unit 20E receives the observation result from the observation unit 10E via the transmission line 1, and calculates a communication volume VE per unit time due to the message included in the received observation result. The communication volume VE indicates the communication volume per unit time due to the message received via the communication port 122A by the switch device 144. The calculation unit 20E outputs load information indicating the calculated communication volume VE, to the detection unit 34.

For example, the calculation unit 20F generates load information, based on the observation result from the observation unit 10F. More specifically, the calculation unit 20F receives the observation result from the observation unit 10F via the transmission line 1, and calculates a communication volume VF per unit time due to the message included in the received observation result. The communication volume VF indicates the communication volume per unit time due to the message received via the communication port 122D by the switch device 144. The calculation unit 20F outputs load information indicating the calculated communication volume VF, to the detection unit 34.

The detection unit 34 identifies, in a detection process, an abnormality location in the network 204, based on consistency for each combination of two pieces of load information included in the five pieces of load information received from the calculation units 20A, 20B, 20D, 20E, 20F.

For example, upon reception of the load information from the calculation units 20A, 20B, 20D, 20E, 20F, the detection unit 34 identifies an abnormality location in the network 204, based on a comparison result for each combination of two communication volumes included in the communication volumes VA, VB, VD, VE, VF indicated by the received five pieces of load information.

As an example, the detection unit 34 calculates the communication volume VAD, which is the sum of the communication volume VA and the communication volume VD and a communication volume VEF, which is the sum of the communication volume VE and the communication volume VF. When the absolute value of the difference between the communication volume VAD and the communication volume VB, the absolute value of the difference between the communication volume VEF and the communication volume VB, and the absolute value of the difference between the communication volume VAD and the communication volume VEF are each less than a predetermined value, the detection unit 34 determines that no abnormality in the network 204 has occurred.

On the other hand, when at least one of the absolute value of the difference between the communication volume VAD and the communication volume VB, the absolute value of the difference between the communication volume VEF and the communication volume VB, and the absolute value of the difference between the communication volume VAD and the communication volume VEF is equal to or larger than the predetermined value, the detection unit 34 determines that an abnormality in the network 204 has occurred.

For example, when the value obtained by subtracting the communication volume VB from the communication volume VAD is equal to or larger than a predetermined value, and the value obtained by subtracting the communication volume VA from the communication volume VE is equal to or larger than a predetermined value, messages in a number larger than an assumed number have arrived at the communication port 122A in the switch device 144, and thus, the detection unit 34 determines that an abnormality such as insertion of an unauthorized message addressed to the communication apparatus 111B has occurred between the extraction device 121A and the switch device 144.

For example, when the value obtained by subtracting the communication volume VB from the communication volume VAD is equal to or larger than a predetermined value and the value obtained by subtracting the communication volume VD from the communication volume VF is equal to or larger than a predetermined value, messages in a number larger than an assumed number have arrived at the communication port 122D in the switch device 144, and thus, the detection unit 34 determines that an abnormality such as insertion of an unauthorized message addressed to the communication apparatus 111B has occurred between the extraction device 121D and the switch device 144.

For example, when having determined that an abnormality in the network 204 has occurred, the detection unit 34 notifies the manager of the network 204 of the determination result including the identified abnormality location by means of a sound or a display.

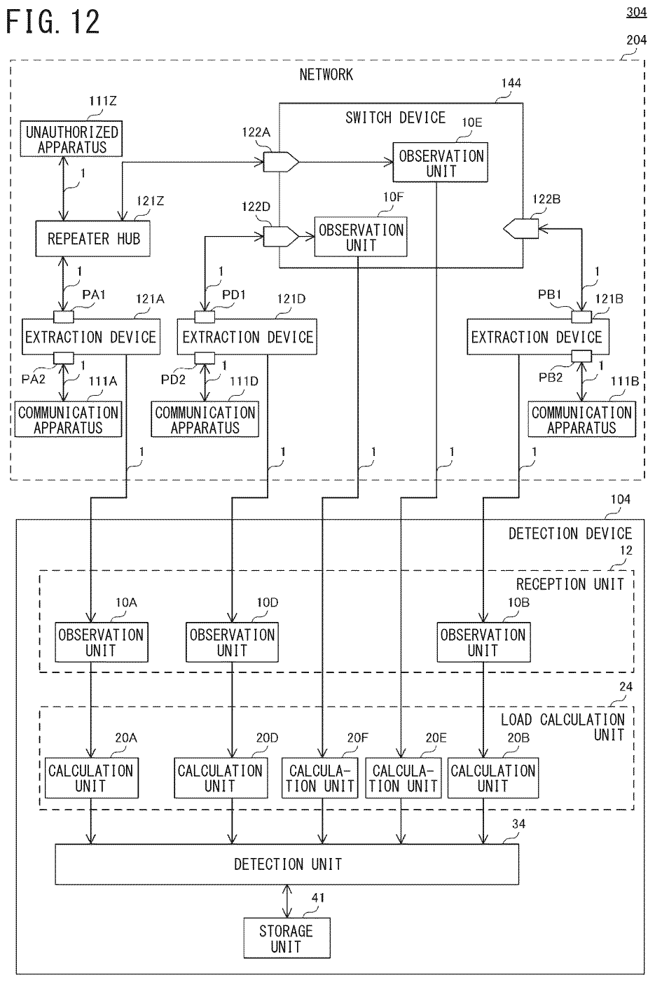

FIG. 12 shows a state where an unauthorized apparatus is added to the detection target network of the detection system according to the fourth embodiment of the present disclosure. FIG. 12 shows a state where an unauthorized apparatus 111Z and a repeater hub 121Z are added to the network 204. The repeater hub 121Z is provided between the communication port 122A in the switch device 144 and the extraction device 121A, and is connected to the communication port PA1 in the extraction device 121A via the transmission line 1. The unauthorized apparatus 111Z is connected to the repeater hub 121Z via the transmission line 1.

The unauthorized apparatus 111Z generates an unauthorized message addressed to the communication apparatus 111B according to the communication protocol Prtl and pretending as if the transmission source thereof were the communication apparatus 111A, and transmits the generated unauthorized message to the repeater hub 121Z.

The repeater hub 121Z outputs a message received from the extraction device 121A to the switch device 144 and the unauthorized apparatus 111Z, outputs a message received from the switch device 144 to the extraction device 121A and the unauthorized apparatus 111Z, and outputs the unauthorized message received from the unauthorized apparatus 111Z to the switch device 144 and the extraction device 121A.

For example, the communication apparatus 111D transmits a message to the communication apparatus 111B via the switch device 144. The observation unit 10D in the reception unit 12 of the detection device 104 receives, via the transmission line 1, the message transmitted by the communication apparatus 111D and extracted by the extraction device 121D. The observation unit 10F receives the message transmitted by the communication apparatus 111D.

The communication apparatus 111B receives the message from the communication apparatus 111D via the switch device 144, and transmits a response message addressed to the communication apparatus 111D, to the switch device 144. The observation unit 10B in the reception unit 12 of the detection device 104 receives, via the transmission line 1, the response message transmitted by the communication apparatus 111B and extracted by the extraction device 121B.

For example, the communication apparatus 111A transmits a message to the communication apparatus 111B via the switch device 144. The observation unit 10A in the reception unit 12 of the detection device 104 receives, via the transmission line 1, the message transmitted by the communication apparatus 111A and extracted by the extraction device 121A. On the other hand, the observation unit 10E receives the message transmitted by the communication apparatus 111A, and in addition, the unauthorized message transmitted by the unauthorized apparatus 111Z. It should be noted that, since the extraction device 121A receives, via the communication port PA1, the unauthorized message transmitted by the unauthorized apparatus 111Z, the extraction device 121A transmits the unauthorized message to the communication apparatus 111A via the communication port PA2, whereas the extraction device 121A does not perform extraction of the unauthorized message through the filter fa and duplication thereof. Therefore, the unauthorized message transmitted by the unauthorized apparatus 111Z does not arrive at the observation unit 10A in the reception unit 12 of the detection device 104.

The communication apparatus 111B receives the message from the communication apparatus 111A via the switch device 144, and transmits a response message addressed to the communication apparatus 111A, to the switch device 144. The observation unit 10B in the reception unit 12 of the detection device 104 receives, via the transmission line 1, the response message transmitted by the communication apparatus 111B and extracted by the extraction device 121B.

The communication apparatus 111B receives the unauthorized message from the unauthorized apparatus 111Z via the switch device 144, and transmits a response message addressed to the communication apparatus 111A, to the switch device 144. The observation unit 10B in the reception unit 12 of the detection device 104 receives, via the transmission line 1, the response message transmitted by the communication apparatus 111B and extracted by the extraction device 121B.

Therefore, the communication volume VB calculated by the calculation unit 20B has a value larger than that of the communication volume VAD, which is the sum of the communication volume VA calculated by the calculation unit 20A and the communication volume VD calculated by the calculation unit 20D. In addition, the communication volume VE calculated by the calculation unit 20E has a value larger than that of the communication volume VA.

In this case, since the value obtained by subtracting the communication volume VB from the communication volume VAD is equal to or larger than a predetermined value, the value obtained by subtracting the communication volume VD from the communication volume VF is less than a predetermined value, and the value obtained by subtracting the communication volume VA from the communication volume VE is equal to or larger than a predetermined value, the detection unit 34 determines that an abnormality has occurred between the extraction device 121A and the switch device 144.

Next, another embodiment of the present disclosure will be described with reference to the drawings. In the drawings, the same or corresponding parts are denoted by the same reference signs, and descriptions thereof are not repeated.

### Fifth Embodiment

The present embodiment relates to a detection system 305 that detects an abnormality in a network 205 in which one-to-many multicast communication and broadcast communication by the communication apparatuses 111 are performed, as compared with the detection system 303 according to the third embodiment. Contents other than those described below are the same as those of the detection system 303 according to the third embodiment.

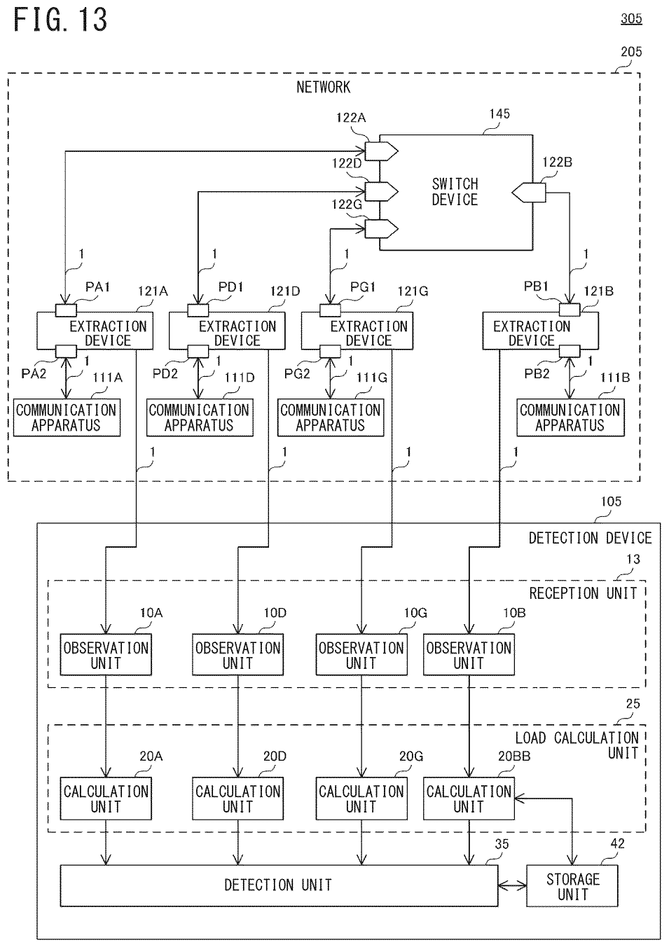

FIG. 13 shows an example of a configuration of a detection system and a detection target network according to a fifth embodiment of the present disclosure. With reference to FIG. 13, as compared with the detection system 303 according to the third embodiment, the detection system 305 includes a detection device 105 instead of the detection device 103, and further includes an extraction device 121G. The extraction device 121G is an example of the extraction device. The extraction device 121G includes communication ports PG1, PG2. The extraction device 121G transmits a message received via one of the communication ports PG1, PG2, via the other of the communication ports PG1, PG2. The detection system 305 detects an abnormality in the network 205.

The network 205 includes communication apparatuses 111A, 111B, 111D, 111G which are each the communication apparatus 111, and a switch device 145. The communication apparatus 111B is an example of the first communication apparatus. The communication apparatuses 111A, 111D, 111G are each an example of the second communication apparatus, and are each an example of the third communication apparatus. The switch device 145 relays information exchanged between the communication apparatuses 111A, 111D, 111G and the communication apparatus 111B. The switch device 145 includes communication ports 122A, 122B, 122D, 122G.

The communication apparatus 111G is connected to the communication port PG2 in the extraction device 121G via the transmission line 1. The communication port PG1 in the extraction device 121G is connected to the communication port 122G in the switch device 143 via the transmission line 1.

In the network 205, transmission and reception of messages are performed between the communication apparatus 111B and the communication apparatuses 111A, 111D, 111G. Here, in the network 205, transmission and reception of messages are not performed between the communication apparatus 111A and the communication apparatus 111D, between the communication apparatus 111D and the communication apparatus 111G, and between the communication apparatus 111A and the communication apparatus 111G.

For example, the communication apparatus 111B periodically or non-periodically multicasts a message according to the communication protocol Prtl to some or all of the communication apparatuses 111A, 111D, 111G via the switch device 145.

The communication apparatuses 111, among the communication apparatuses 111A, 111D, 111G, that are included in a multicast group and identified by a multicast address stored in the message transmitted by the communication apparatus 111B each generate a response message according to the communication protocol Prtl and transmit the generated response message to the communication apparatus 111B via the switch device 145.

For example, the communication apparatus 111B periodically or non-periodically broadcasts a message according to the communication protocol Prtl to the communication apparatuses 111A, 111D, 111G via the switch device 145.

The communication apparatuses 111, among the communication apparatuses 111A, 111D, 111G, that should perform a response to the message received from the communication apparatus 111B via the switch device 145 each generate a response message according to the communication protocol Prtl and transmit the generated response message to the communication apparatus 111B via the switch device 145.

The extraction device 121G includes a filter fg (not shown) that extracts a message received via the communication port PG2 and including the address of the communication apparatus 111G as the transmission source address. The extraction device 121G extracts a message extracted through the filter fg among messages received via the communication port PG2. The extraction device 121G transmits the extracted message via the communication port PG1. The extraction device 121G further transmits a duplicate of the extracted message to the detection device 105 via the transmission line 1.

As compared with the detection device 103 according to the third embodiment, the detection device 105 includes a reception unit 13 instead of the reception unit 12, includes a load calculation unit 25 instead of the load calculation unit 23, includes a detection unit 35 instead of the detection unit 33, and includes a storage unit 42 instead of the storage unit 41. As compared with the reception unit 12, the reception unit 13 further includes an observation unit 10G, which is the observation unit 10. As compared with the load calculation unit 23, the load calculation unit 25 includes a calculation unit 20BB which is the calculation unit 20, instead of the calculation unit 20B, and further includes a calculation unit 20G which is the calculation unit 20. The load calculation unit 25 is an example of the acquisition unit. The detection device 105 performs a detection process of detecting an abnormality in the network 205.

The storage unit 42 has stored therein network information indicating the topology of the network 205 and the communication protocol Prtl in the network 205. For example, the network information is stored in the storage unit 42 by the manager of the network 205.

The storage unit 42 has stored therein an address correspondence table Tb1 indicating a correspondence relationship between a destination address included in a message transmitted by the communication apparatus 111B, type information indicating the type of the message, and destination apparatus information indicating the number of destination communication apparatuses 111 of the message. The type information in the address correspondence table Tb1 indicates which of a unicast message, a multicast message, and a broadcast message the message transmitted by the communication apparatus 111B is. For example, in the address correspondence table Tb1, the number of destination communication apparatuses 111 corresponding to a broadcast message is “3”. The address correspondence table Tb1 is acquired from the communication apparatus 111 or the switch device 145 in advance by the detection unit 35 and is stored in the storage unit 42, for example. The address correspondence table Tb1 may be stored in the storage unit 42 by the manager of the network 205.

For example, the observation unit 10G observes an output of an extracted message performed by the extraction device 121G. More specifically, the observation unit 10G receives, via the transmission line 1, a message extracted by the extraction device 121G. The observation unit 10G periodically or non-periodically extracts one or a plurality of messages according to the communication protocol Prtl described above, out of one or a plurality of messages received in the observation period T1 having a predetermined length. The observation unit 10G outputs an observation result including each extracted message, to the calculation unit 20G.

Upon reception of the observation result from the observation unit 10G, the calculation unit 20G calculates a communication volume VG per unit time due to the message included in the received observation result. The communication volume VG indicates the communication volume per unit time due to the message that includes the address of the communication apparatus 111G as the transmission source address and that passes through the extraction device 121G. The calculation unit 20G outputs load information indicating the calculated communication volume VG, to the detection unit 35.

The calculation unit 20BB calculates the communication volume VB, based on the number of response messages predicted based on the type of the message transmitted by the communication apparatus 111B, and the communication volume of the message transmitted by the communication apparatus 111B. Specifically, upon reception of an observation result from the observation unit 10B, the calculation unit 20BB predicts, for each message included in the received observation result, the number of response messages to the communication apparatus 111B with respect to the message transmitted by the communication apparatus 111B, and calculates a product Pmv of the predicted number of response messages and the communication volume of the message transmitted by the communication apparatus 111B. Then, the calculation unit 20BB calculates the sum of the product Pmv for each message included in the observation result, as the communication volume VB.

More specifically, the calculation unit 20BB acquires the destination address from a message included in the observation result, and acquires the type information and the destination apparatus information that correspond to the acquired destination address, from the address correspondence table Tb1 in the storage unit 42.

When the type of the message indicated by the acquired type information is the unicast message, the calculation unit 20BB predicts that the number of response messages to the communication apparatus 111B with respect to the unicast message is one. Then, the calculation unit 20BB calculates one times the communication volume of the unicast message as the product Pmv.

For example, when the type of the message indicated by the acquired type information is the multicast message and the number of destination communication apparatuses 111 indicated by the acquired destination apparatus information is, for example, “2”, the calculation unit 20BB predicts that the number of response messages to the communication apparatus 111B with respect to the multicast message is two. Then, the calculation unit 20BB calculates twice the communication volume of the multicast message as the product Pmv.

For example, when the type of the message indicated by the acquired type information is the broadcast message, the number of destination communication apparatuses 111 indicated by the destination apparatus information corresponding to the type information in the address correspondence table Tb1 is “3” as described above, and thus, the calculation unit 20BB predicts that the number of response messages to the communication apparatus 111B with respect to the broadcast message is three. Then, the calculation unit 20BB calculates three times the communication volume of the broadcast message as the product Pmv.

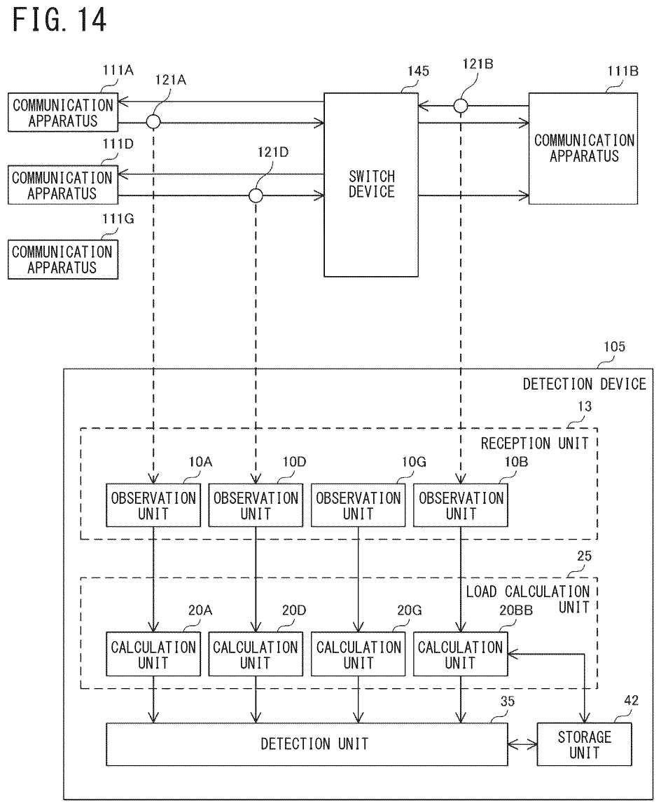

FIG. 14 shows an example of the detection process performed by the detection device according to the fifth embodiment of the present disclosure.

With reference to FIG. 14, for example, the communication apparatus 111B multicasts a message to the communication apparatuses 111A, 111D via the switch device 145. The observation unit 10B in the reception unit 13 of the detection device 105 receives, via the transmission line 1, the message transmitted by the communication apparatus 111B and extracted by the extraction device 121B, and outputs an observation result including the received message to the calculation unit 20BB.

The communication apparatus 111A receives the message from the communication apparatus 111B via the switch device 145, and transmits a response message to the communication apparatus 111B via the switch device 145. The observation unit 10A in the reception unit 13 of the detection device 105, receives, via the transmission line 1, the response message transmitted by the communication apparatus 111A and extracted by the extraction device 121A, and outputs an observation result including the received response message to the calculation unit 20A.

The communication apparatus 111D receives the message from the communication apparatus 111B via the switch device 145, and transmits a response message to the communication apparatus 111B via the switch device 145. The observation unit 10D in the reception unit 13 of the detection device 105 receives, via the transmission line 1, the response message transmitted by the communication apparatus 111D and extracted by the extraction device 121D, and outputs an observation result including the received response message to the calculation unit 20D.

Upon reception of the observation result from the observation unit 10B, the calculation unit 20BB acquires the destination address from the message included in the received observation result, and acquires the type information and the destination apparatus information that correspond to the acquired destination address, from the address correspondence table Tb1 in the storage unit 42. Since the type of the message indicated by the acquired type information is the multicast message and the number of destination communication apparatuses 111 indicated by the acquired destination apparatus information is “2”, the calculation unit 20BB predicts that the number of response messages to the communication apparatus 111B with respect to the multicast message is “2”, and calculates twice of the communication volume of the multicast message as the communication volume VB.

When the network 205 is in a normal state, the difference between: the communication volume VAD, which is the sum of the communication volume VA calculated by the calculation unit 20A and the communication volume VD calculated by the calculation unit 20D; and the communication volume VB calculated by the calculation unit 20BB is zero, for example. On the other hand, when an abnormality such as insertion of an unauthorized message has occurred in the network 205, the consistency between the communication volume VAD and the communication volume VB decreases and the difference between the communication volume VAD and the communication volume VB has a large value. Therefore, also in the network 205 in which one-to-many multicast communication and broadcast communication are performed by the communication apparatuses 111, the detection unit 35 can determine whether or not an abnormality in the network 205 has occurred, based on the difference between the communication volume VAD and the communication volume VB.

### Modification 1

The calculation unit 20BB is configured to, when the type of the message indicated by the type information acquired from the address correspondence table Tb1 is the broadcast message, predict that the number of response messages to the communication apparatus 111B with respect to the broadcast message is three, based on the number of destination communication apparatuses 111 indicated by the destination apparatus information corresponding to the type information in the address correspondence table Tb1, and calculate the communication volume VB, based on the predicted number of response messages and the communication volume of the message. However, the present disclosure is not limited thereto. For example, the calculation unit 20BB calculates the communication volume VB, based on the number of response messages predicted further based on header information of the message transmitted by the communication apparatus 111B, and the communication volume of the message.

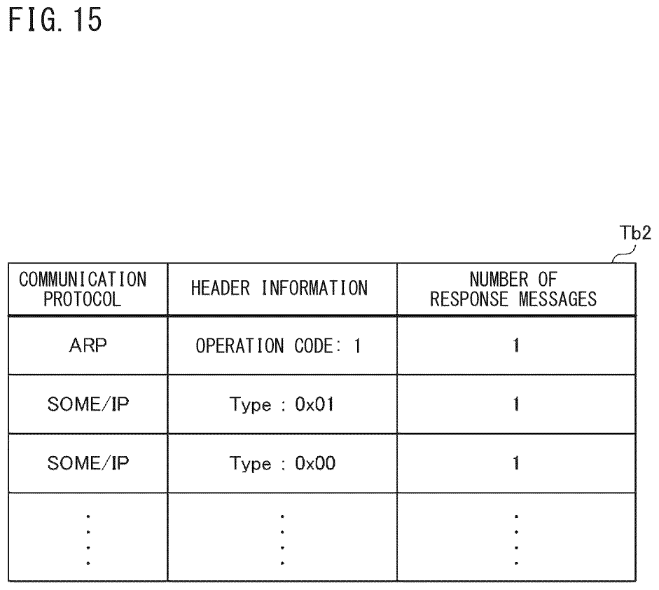

FIG. 15 shows an example a response information table stored in the storage unit in the detection device according to the fifth embodiment of the present disclosure.

With reference to FIG. 15, the storage unit 42 has stored therein a response information table Tb2 indicating, for each communication protocol Prtl of a broadcast message transmitted by the communication apparatus 111B, a correspondence relationship between header information of the broadcast message and a predicted number of response messages to the communication apparatus 111B. The response information table Tb2 is acquired from the communication apparatus 111 or the switch device 145 in advance by the detection unit 35 and is stored in the storage unit 42, for example.

For example, the response information table Tb2 indicates that, when the operation code of a broadcast message according to ARP is “1”, the predicted number of response messages is “1”. This is because, when an ARP request message has been broadcast by the communication apparatus 111B, one communication apparatus 111, among the communication apparatuses 111A, 111D, 111G, that has an IP address that matches the IP address designated by the ARP request message transmits an ARP response message, as a response message, to the communication apparatus 111B. The operation code is an example of header information.

For example, the response information table Tb2 indicates that, when Type in the SOME/IP-SD (Service Discovery) header of a broadcast message according to SOME/IP is “0x01”, the broadcast message is an Offer message according to SOME/IP and the predicted number of response messages is “1”. This is because, when an Offer message is broadcast by the communication apparatus 111B operating as a server, one communication apparatus 111, among the communication apparatuses 111A, 111D, 111G operating as clients, that should receive provision of a service designated by the Offer message transmits a Subscribe message according to SOME/IP, as a response message, to the communication apparatus 111B. Here, the digits beginning with “0x” means that the digits after “0x” are represented by a hexadecimal number. Type in the SOME/IP-SD header is an example of the header information.

For example, the response information table Tb2 indicates that, when Type in the SOME/IP-SD header of a broadcast message according to SOME/IP is “0x00”, the broadcast message is a Find message according to SOME/IP and the predicted number of response messages is “1”. This is because, when the communication apparatus 111B operates as a client and the communication apparatuses 111A, 111D, 111G operate as servers, if a Find message is broadcast by the communication apparatus 111B, one communication apparatus 111, among the communication apparatuses 111A, 111D, 111G, that can provide a service designated by the Find message transmits an Offer message according to SOME/IP, as a response message, to the communication apparatus 111B.

When the type of the message indicated by the type information acquired from the address correspondence table Tb1 in the storage unit 42 is the broadcast message, the calculation unit 20BB acquires the header information of the broadcast message.

The calculation unit 20BB refers to the response information table Tb2 in the storage unit 42, and when the acquired header information is included in the response information table Tb2, the calculation unit 20BB recognizes the predicted number of response messages corresponding to the header information. On the other hand, when the acquired header information is not included in the response information table Tb2, the calculation unit 20BB predicts that the number of response messages is three, based on the address correspondence table Tb1, as described above. The calculation unit 20BB calculates the product Pmv of the predicted number of response messages and the communication volume of the broadcast message. Then, the calculation unit 20BB calculates the sum of the product Pmv for each message included in the observation result, as the communication volume VB.

As an example, when the operation code of a broadcast message according to ARP is “1”, the calculation unit 20BB recognizes, by referring to the response information table Tb2, that the number of response messages to the communication apparatus 111B with respect to the broadcast message is one. Then, the calculation unit 20BB calculates one times the communication volume of the broadcast message as the product Pmv.

### Modification 2

The calculation unit 20BB is configured to acquire the type information and the destination apparatus information from the address correspondence table Tb1 in the storage unit 42, predict the number of response messages to the communication apparatus 111B, based on the acquired type information and destination apparatus information, and calculate the communication volume VB, based on the predicted number of response messages and the communication volume of the message. However, the present disclosure is not limited thereto. For example, the calculation unit 20BB calculates the communication volume VB, based on the number of response messages predicted further based on the window size in communication according to TCP (Transmission Control Protocol), and the communication volume of the message.

More specifically, when communication according to TCP is performed between communication apparatuses 111, control of the window size is performed in some cases. When control of the window size is performed, the communication apparatuses 111A, 111D, 111G transmit one response message to the communication apparatus 111B via the switch device 145 with respect to a plurality of messages received from the communication apparatus 111B via the switch device 145. Specifically, for example, when the window size is set to “3”, the communication apparatuses 111A, 111D, 111G transmit one response message to the communication apparatus 111B via the switch device 145 with respect to three messages received from the communication apparatus 111B via the switch device 145.

For example, the storage unit 42 has stored therein a window control table Tb3 indicating a correspondence relationship between a port number, whether or not window control is being performed, and a window size when the window control is being performed.

The calculation unit 20BB acquires the port number from the message included in the observation result received from the observation unit 10B, and acquires the window size corresponding to the acquired port number from the window control table Tb3 in the storage unit 42. The calculation unit 20BB predicts the number of response messages to the communication apparatus 111B, based on the acquired window size. The calculation unit 20BB calculates the product Pmv of the predicted number of response messages and the communication volume of the message included in the observation result. Then, the calculation unit 20BB calculates the sum of the product Pmv for each message included in the observation result, as the communication volume VB.

The disclosed embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiments are realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a storage medium such as a CD-ROM (Compact Disc Read Only Memory), a DVD-ROM (Digital Versatile Disk Read Only Memory), or a semiconductor memory, to be installed in the memory from the storage medium.

The above description includes the features in the additional note below.

### Additional Note 1

A detection device configured to detect an abnormality in a network,
in the network, transmission and reception of a plurality of messages including a response message being performed by a plurality of communication apparatuses,
the detection device comprising:
an acquisition unit configured to acquire a plurality of pieces of load information respectively indicating communication loads at a plurality of locations in the network; and
a detection unit configured to detect an abnormality in the network, based on consistency between the plurality of pieces of load information acquired by the acquisition unit, wherein
in the network, transmission and reception of the messages by the plurality of communication apparatuses are performed via a switch device, and
the acquisition unit acquires the load information indicating the communication load in the switch device.

### REFERENCE SIGNS LIST

1 transmission line
10, 10A, 10B, 10C, 10D, 10E, 10F, 10G observation unit
11, 12, 13 reception unit
20, 20A, 20B, 20C, 20D, 20E, 20F, 20G, 20BB calculation unit
21, 22, 23, 24, 25 load calculation unit (acquisition unit)
31, 32, 33, 34, 35 detection unit
41, 42 storage unit
111A, 111B, 111D, 111G communication apparatus
111X, 111Y, 111Z unauthorized apparatus
121A, 121B, 121D, 121G extraction device
121X, 121Y, 121Z repeater hub
122A, 122B, 122D, 122G communication port
101, 102, 103, 104, 105 detection device
141, 142, 143, 144, 145 switch device
201, 202, 203, 204, 205 network
301, 302, 303, 304, 305 detection system
Tb1 address correspondence table
Tb2 response information table
PA1, PA2, PB1, PB2, PD1, PD2, PG1, PG2 communication port

1. A detection device configured to detect an abnormality in a network,
in the network, transmission and reception of a plurality of messages including a response message being performed by a plurality of communication apparatuses,
the detection device comprising:
an acquisition unit configured to acquire a plurality of pieces of load information respectively indicating communication loads at a plurality of locations in the network, the plurality of pieces of load information respectively indicating communication loads due to the messages whose transmission sources are different from each other; and
a detection unit configured to detect an abnormality in the network, based on consistency between the plurality of pieces of load information acquired by the acquisition unit.

2. The detection device according to claim 1, wherein
the acquisition unit acquires three or more pieces of the load information respectively indicating communication loads at three or more locations in the network, and
the detection unit identifies an abnormality location in the network, based on the consistency for each combination of two pieces of the load information included in the three or more pieces of load information.

3. The detection device according to claim 1, wherein
in the network, transmission and reception of the messages are performed between a first of the communication apparatuses and a plurality of the communication apparatuses different from the first communication apparatus,
the acquisition unit acquires a first of the load information indicating a communication volume of the message whose transmission source is the first communication apparatus, and a plurality of pieces of a second of the load information each indicating a communication volume of the message whose transmission source is the communication apparatus different from the first communication apparatus, the plurality of pieces of the second load information respectively corresponding to a plurality of the communication apparatuses different from the first communication apparatus, and
the detection unit detects an abnormality in the network, based on the consistency between the communication volume of the message indicated by the first load information and the communication volume of the message indicated by the second load information.

4. The detection device according to claim 1, wherein
the detection device further comprises
an observation unit configured to observe an output, of the message having been extracted, performed by an extraction device, the extraction device being configured to extract the message transmitted from the communication apparatus, the extraction device being configured to output the message having been extracted, to another of the communication apparatuses and the detection device, and
the acquisition unit generates the load information, based on an observation result from the observation unit.

5. The detection device according to claim 3, wherein
the acquisition unit acquires the load information indicating a communication load calculated based on a number of the response messages predicted based on a type of the message transmitted by the first communication apparatus and the communication volume of the message transmitted by the first communication apparatus.

6. The detection device according to claim 5, wherein
the acquisition unit acquires the load information indicating a communication load calculated based on a number of the response messages predicted further based on header information of the message transmitted by the first communication apparatus.

7. A detection system configured to detect an abnormality in a network,
in the network, transmission and reception of a plurality of messages including a response message being performed by a plurality of communication apparatuses,
the detection system comprising:
a plurality of extraction devices configured to respectively extract the messages whose transmission sources are different from each other, the messages respectively passing through locations different from each other in the network;
a plurality of observation units configured to respectively observe the messages extracted by the plurality of extraction devices;
a load calculation unit configured to generate, based on observation results by the plurality of observation units, a plurality of pieces of load information respectively indicating communication loads at a plurality of locations in the network; and
a detection unit configured to detect an abnormality in the network, based on consistency between the plurality of pieces of load information generated by the load calculation unit.

8. A detection method performed in a detection device configured to detect an abnormality in a network,
in the network, transmission and reception of a plurality of messages including a response message being performed by a plurality of communication apparatuses,
the detection method comprising the steps of:
acquiring a plurality of pieces of load information respectively indicating communication loads at a plurality of locations in the network, the plurality of pieces of load information respectively indicating communication loads due to the messages whose transmission sources are different from each other; and
detecting an abnormality in the network, based on consistency between the plurality of pieces of load information having been acquired.

9. The detection device according to claim 1, wherein
the network includes a switch device configured to relay the messages transmitted and received between the communication apparatuses, and
each piece of the load information indicates the communication load in a transmission path between the switch device and a corresponding one of the communication apparatuses serving as the transmission sources.

10. The detection device according to claim 1, wherein
the network includes a switch device configured to relay the messages transmitted and received between the communication apparatuses, and
the plurality of pieces of load information include the load information indicating the communication load in the switch device and the load information indicating the communication load in a transmission path between the switch device and each communication apparatus serving as the transmission source.
